(19) United States
(12) Patent Application Publication
(10) Pub. No.: US 2014/0019635 A1
(43) Pub. Date: Jan. 16, 2014

(54) OPERATION AND ARCHITECTURE FOR DASH STREAMING CLIENTS

(71) Applicant: VID SCALE, INC., Wilmington, DE (US)

(72) Inventors: Yuriy Reznik, San Diego, CA (US); Eduardo Asbun, San Diego, CA (US); Osama Lotfallah, King of Prussia, PA (US); Hang Liu, North Potomac, MD (US)

(21) Appl. No.: 13/941,085

(22) Filed: Jul. 12, 2013

Related U.S. Application Data
(60) Provisional application No. 61/671,334, filed on Jul. 13, 2012.
(60) Provisional application No. 61/679,023, filed on Aug. 2, 2012.

(51) Int. Cl. H04L 29/06

(52) U.S. Cl. CPC H04L 65/607
USPC 709/231

(57) ABSTRACT

An adaptive HTTP streaming client may prevent network-level transcoding, may detect that transcoding takes place and implement a custom reaction, and/or may adopt rate estimation and stream switching logic, which may produce meaningful decisions in the presence of caching and transcoding operations in the network. A streaming client may use hash values of received segments, attributes of a received stream of content, and/or segment length checks of representations of segments to determine if the segments were transcoded. A streaming client may use random split range-based HTTP GET requests to deter transcoding. A streaming client may use split range-based HTTP GET requests to improve the accuracy of its bandwidth estimation. A streaming client may use any combination of the techniques described herein to detect transcoding, deter transcoding, adopt improved bandwidth and/or bitrate estimation, and adopt improved switching logic.

### CROSS-REFERENCE TO RELATED APPLICATIONS

This application claims the benefit of U.S. Provisional Patent Application No. 61/671,334, filed Jul. 13, 2012, titled “Transcoding/Transrating/Caching—Aware Operation And Rate Switching”, and U.S. Provisional Patent Application No. 61/679,023, filed Aug. 2, 2012, titled “Dynamic Adaptive Streaming Over HTTP (Dash) Clients and Methods”, the disclosures of both applications being herby incorporated by reference herein in their respective entirety, for all purposes.

### BACKGROUND

Streaming content over wireless and wired networks may require adaptation due to variable bandwidth in the network. Streaming content providers may publish content encoded at multiple rates and/or resolutions. This may enable clients to adapt to varying channel bandwidth. The MPEG/3GPP DASH standard may define a framework for the design of an end-to-end service that may enable efficient and high-quality delivery of streaming services over wireless and wired networks.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A streaming client may take measures to block network-level transcoding of content it receives. A streaming client may detect the fact that transcoding takes place and implement a custom reaction, such as but not limited to, notifying the user that s/he is not receiving original content. A streaming client may adopt robust rate estimation and stream switching logic, which may produce decisions in the presence of caching and transcoding operations in the network.

An adaptive HTTP streaming client may prevent network-level transcoding, may detect that transcoding takes place and implement a custom reaction, and/or may adopt rate estimation and stream switching logic, which may produce meaningful decisions in the presence of caching and transcoding operations in the network. A streaming client may use hash values of received segments to determine if the segment was transcoded. A streaming client may use attributes of a received stream of content to determine if the segments were transcoded. A streaming client may use segment length checks of representations of segments to determine if the segments were transcoded. A streaming client may use random split range-based HTTP GET requests to deter transcoding. A streaming client may use split range-based HTTP GET requests to improve the accuracy of its bandwidth estimation. A streaming client may use any combination of the techniques described herein to detect transcoding, deter transcoding, adopt improved bandwidth and/or bitrate estimation, and adopt improved switching logic.

Embodiments contemplate DASH clients and methods. Further, the present disclosure provides an analysis of DASH specification, including it normative and informative sections, and provides disclosure about algorithms and architecture of DASH streaming clients.

In one or more embodiments, a technique may be implemented at a DASH client. The method may include receiving an MPD. Further, the method may include selecting a set of adaptation sets. The method may also include generating a list of segments for each selected representation of the adaptation sets. Further, the method includes requesting the segments based on the generated list.

Embodiments contemplate DASH clients and related methods. One or more embodiments may be implemented at a DASH client. Embodiments may include receiving an MPD. Further, embodiments may include selecting a set of adaptation sets. Embodiments may also include generating a list of segments for one or more, or each, selected representation of the adaptation sets. Further, embodiments may include requesting the segments based on the generated list.

Embodiments contemplate one or more techniques of bandwidth adaptive streaming in a wireless transmit/receive unit (WTRU). The techniques may include receiving a description file from at least one network node using secure hypertext transport protocol (HTTPS). The description file may comprise hash values of encoded media segments. The techniques may also include receiving an encoded media segment from the network node. The encoded media segment may comprise a hash value. The techniques may also include determining if the hash value of the encoded video segment is substantially similar to a corresponding hash value of the description file. Also, the techniques may include decoding the encoded media segment upon the hash value of the encoded video segment being substantially similar to the corresponding hash value of the description file.

Embodiments contemplate one or more techniques of bandwidth adaptive streaming in a wireless transmit/receive unit (WTRU). Techniques may comprise determining at the WTRU a random boundary between one or more hypertext transport protocol (HTTP) GET requests of streaming content to deter transcoding. Techniques may also include transmitting from the WTRU a first HTTP GET request for a first portion of a segment of the streaming content to a network. A first range of the first portion may end at the random boundary. Techniques may also include receiving the first portion of the segment of the streaming content from the network. Also, techniques may include transmitting from the WTRU a second HTTP GET request for a second portion of the segment of the streaming content to the network. Techniques may also include receiving the second portion of the segment of the streaming content from the network.

Embodiments contemplate one or more techniques that may include receiving a Media Presentation Description (MPD) at a Dynamic Adaptive Streaming over HTTP (DASH) client device. Techniques may also include selecting one or more adaptation sets. Techniques may also include selecting one or more representations of the one or more adaptation sets. Also, techniques may include generating a list of segments for each selected representation of the adaptation sets. Techniques may also include requesting the segments based on the generated list.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an another example radio access network and another example core network that may be used within the communications system illustrated in FIG. 1A.

FIG. 1E is a system diagram of an another example radio access network and another example core network that may be used within the communications system illustrated in FIG. 1A.

FIG. 2 is a diagram that illustrates an example of content encoded at different bit rates consistent with embodiments.

FIG. 3 is a graph that illustrates an example of bandwidth adaptive streaming consistent with embodiments.

FIG. 4 is a diagram that illustrates an example of a sequence of interactions between a streaming client and a HTTP server during a streaming session consistent with embodiments.

FIG. 5 is a diagram that illustrates an example of architectures and insertion points for solutions in wireless communication systems consistent with embodiments.

FIG. 6 is a flowchart of an example of the use of a technique that uses hashes to detect transcoding consistent with embodiments.

FIG. 7 is a flowchart of an example of the use of a technique that uses stream attributes to detect transcoding consistent with embodiments.

FIG. 8 is a flowchart of an example of the use of a technique that uses segment length check to detect transcoding consistent with embodiments.

FIG. 9 is a flowchart of an example of the use of a technique that uses split-access to segment to deter transcoding consistent with embodiments.

FIG. 10 is a flowchart of an example of the use of a technique that uses split-access to segments to improve the accuracy of bandwidth estimation consistent with embodiments.

FIG. 11 is a diagram illustrating an example of the high-level architecture of a DASH system consistent with embodiments.

FIG. 12 is a diagram illustrating an example of the logical components of a DASH client model consistent with embodiments.

FIG. 13 is a diagram illustrating an example of a DASH Media Presentation high-level data model consistent with embodiments.

FIG. 14 is a diagram illustrating an example of an encoded video stream with three different types of frames consistent with embodiments.

FIG. 15 is a diagram of an example of six different DASH profiles consistent with embodiments.

FIG. 16 is a diagram of an example system for DASH-based multimedia delivery consistent with embodiments.

FIG. 17 is a diagram of example standardized aspects in DASH consistent with embodiments.

FIG. 18 illustrates a block diagram of an example HTTP access module consistent with embodiments.

FIG. 19 illustrates a block diagram of example MPD and segment list reading modules consistent with embodiments.

FIG. 20 illustrates a block diagram of an example structure of a representation index segment consistent with embodiments.

FIG. 21 illustrates a block diagram of elements of architecture of DASH client consistent with embodiments.

FIG. 22 illustrates a flow chart of example adaptation set selection logic consistent with embodiments.

FIG. 23 illustrates a block diagram of an example overall top-down design of DASH client consistent with embodiments.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. As used herein, the article “a” or “an”, absent further qualification or characterization, may be understood to mean “one or more” or “at least one”, for example.

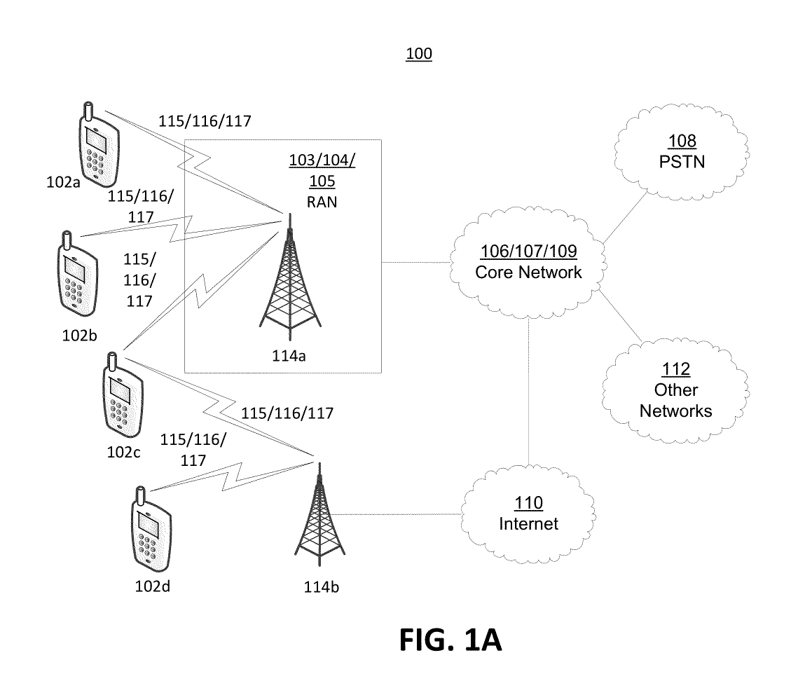

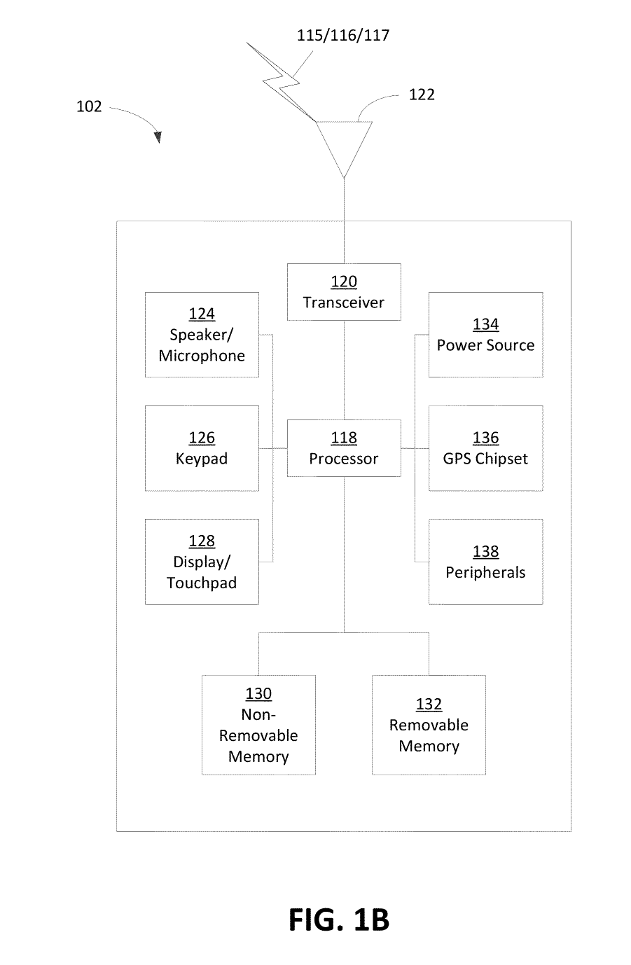

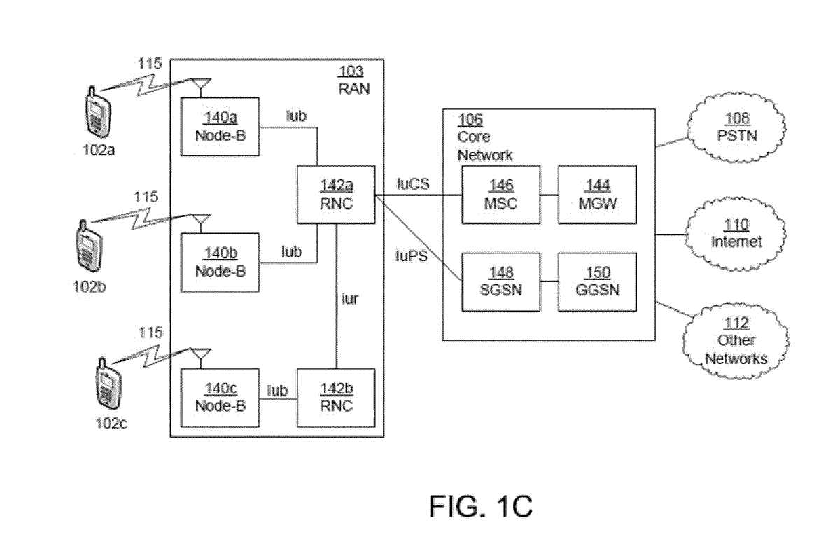

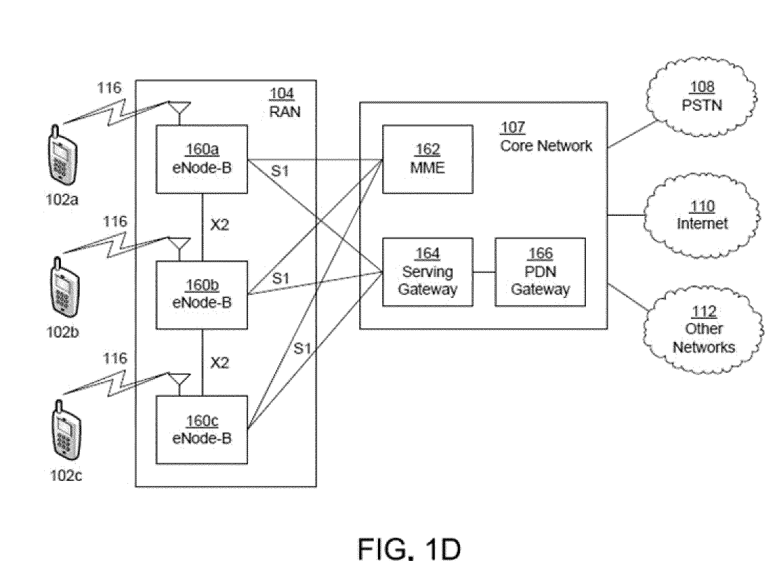

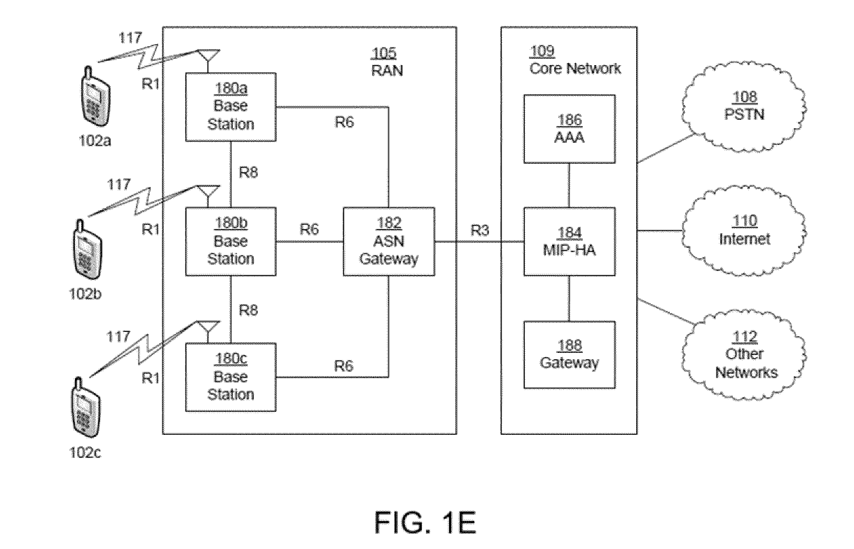

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The techniques discussed below may be performed partially or wholly by a WTRU 102a, 102b, 102c, 102d, a RAN 104, a core network 106, the Internet 110, and/or other networks 112. For example, video streaming being performed by a WTRU 102a, 102b, 102c, 102d may engage various processing as discussed below. A client or streaming client, as used herein, may be a type of WTRU, for example.

Embodiments recognize that the design of MPEG/3GPP DASH standard does not provide solutions to situations where the content that is being delivered is also transcoded at the network layer. It also does not provide solutions to situations when the content may be partially cached at local proxies, which may lead to significantly different access characteristics of different parts of the content. Such transcoding and caching operations may confuse a DASH streaming client's bandwidth estimation logic, leading to irrational stream/rate switching decisions, suboptimal network usage, and/or poor user experience.

A streaming client may take measures to block network-level transcoding of content it receives. A streaming client may detect the fact that transcoding takes place and may implement a custom reaction to it (such as but not limited to, notifying the user that s/he is not receiving original content). A streaming client may adopt robust rate estimation and stream switching logic, which may produce decisions in the presence of caching and transcoding operations in the network. The methods described herein may represent several possible actions that streaming client vendors and/or OTT technology providers may decide to adopt in practical systems to prevent or reduce problems that may be caused by proxies and transcoders.

Streaming in a wired and/or a wireless network (e.g., 3G, WiFi, Internet) may find useful (or perhaps require) adaptation due to variable bandwidth in the network. Bandwidth adaptive streaming, which may be where the rate at which media is streamed to clients may adapt to varying network conditions, may be attractive because it may enable clients to match the rate at which the media is received to their own varying available bandwidth.

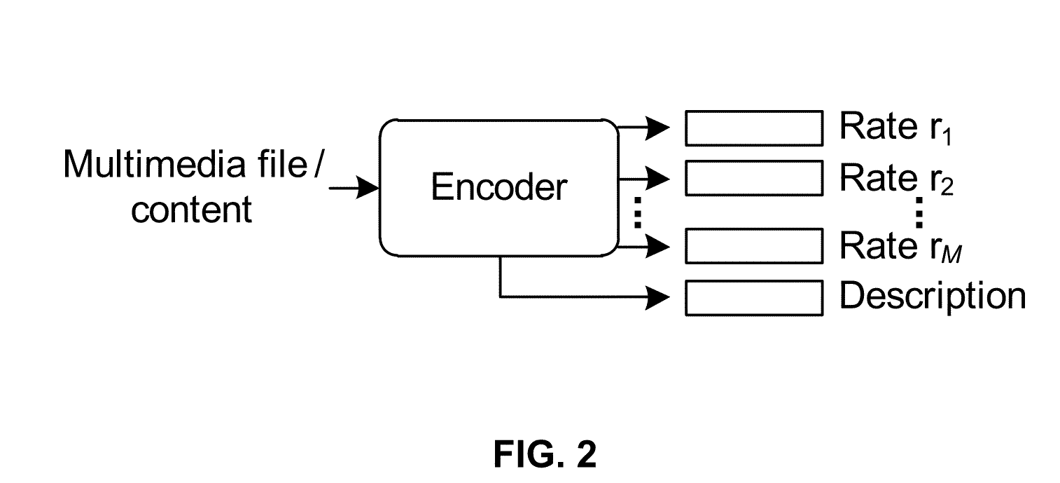

FIG. 2 is a diagram that illustrates an example of content encoded at different bit rates. In a bandwidth adaptive streaming system, the content provider may offer the same content at different bit rates, one example of which is shown in FIG. 2. The content may be encoded at a number of target bit rates (r1, r2, . . . , rM). To achieve these target bit rates, parameters such as visual quality and/or SNR (video), frame resolution (video), frame rate (video), sampling rate (audio), number of channels (audio), and/or codec (video and audio) may be changed. The description file (sometimes referred to as a “manifest”) may provide technical information and/or metadata associated with the content and its multiple representations. The description file may enable selection of the different available rates by a streaming client. Nonetheless, publishing of the content at multiple rates may increase production and storage costs.

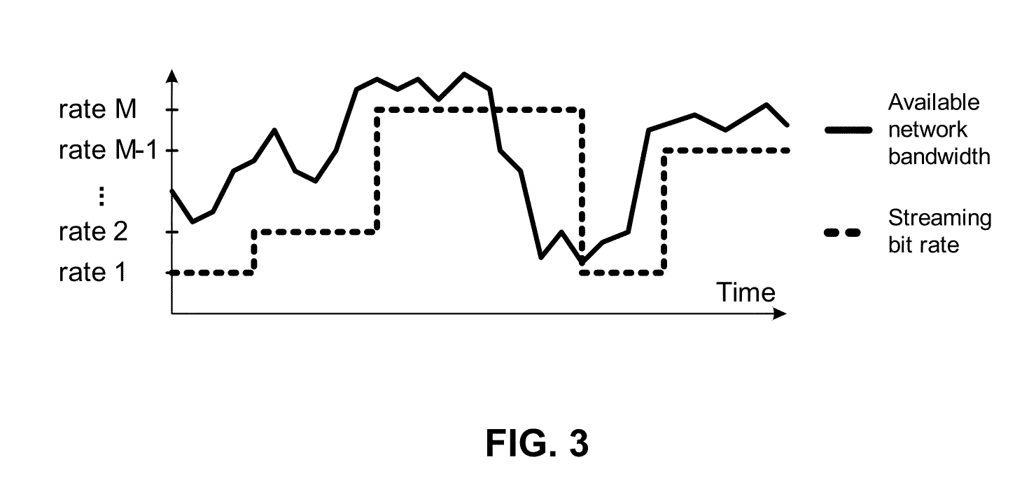

FIG. 3 is a graph illustrating an example of bandwidth adaptive streaming Multimedia streaming systems may support bandwidth adaptation. Streaming WTRUs (also referred to as “streaming clients”) may learn about available bit rates from the media content description. A streaming client may estimate the available bandwidth. A streaming client may control the streaming session by requesting segments at different bit rates, allowing it to adapt to bandwidth fluctuations during playback of multimedia content, one example of which is shown in FIG. 3. Streaming clients may estimate available bandwidth based on factors such as, but not limited to, buffer level, error rate, and delay jitter. In addition to bandwidth, streaming clients may consider other factors, such as power considerations and/or user viewing conditions, in making decisions on which rates/segments to use.

Bandwidth of access networks may vary. This may be due to the underlying technology used (see Table 1) and/or due to number of users, location, and/or signal strength.

TABLE 1
Examples of peak bandwidth of access networks.

| Access technology | | Typical peak bandwidth | |
|---|---|---|---|
| Wireless | 2.5G | 32 | kbps |
| | 3G | 5 | Mbps |
| | LTE | 50 | Mbps |
| WiFi | 802.11b | 5 | Mbps |
| | 802.11g | 54 | Mbps |
| | 802.11n | 150 | Mbps |
| Wired | Dial-up | 64 | kbps |
| | DSL | 3 | Mbps |
| | Fiber | 1 | Gbps |

Streaming content may be viewed in multiple screens, including but not limited to smartphones, tablets, laptops and larger screens such as HDTVs. Table 2 illustrates examples of screen resolutions of various devices that have multimedia streaming capabilities. For example, providing a small number of rates may not be enough to provide a good user experience to a variety of different types of streaming clients.

TABLE 2
Examples of screen resolutions (in pixels) of various
devices capable of multimedia streaming.

| | | Screen |
|---|---|---|
| Device | | resolution: |
| Smartphones | HTC Desire | 800 × 480 |
| | iPhone | 960 × 640 |
| | Galaxy Nexus | 1280 × 720 |
| Tablets | Galaxy Tab | 1024 × 600 |
| | iPad 1, 2 | 1024 × 768 |
| | iPad 3 | 2048 × 1536 |
| Laptops | Notebook | 1024 × 600 |
| | Mid-range laptop | 1366 × 758 |
| | High-end laptop | 1920 × 1080 |
| HDTVs | 720 p | 1280 × 720 |
| | 1080 p | 1920 × 1080 |
| | 4K (future) | 4096 × 2160 |

Examples of screen resolutions are listed in Table 3.

TABLE 3
Some example standard screen resolutions.

| | | Screen |
|---|---|---|
| Name(s) | | resolution |
| 240 p | QVGA | 320 × 240 |
| 360 p | | 640 × 360 |
| 480 p | VGA | 640 × 480 |
| 720 p | | 1280 × 720 |
| 1080 p | Full HD | 1920 × 1080 |

In bandwidth adaptive streaming, a media presentation may be encoded at a plurality of different bit rates. Each encoding may be partitioned into segments of short duration (for example, 2-10 sec). For example, streaming clients may use HTTP to request segments at a bit rate that best matches their current conditions. This may provide for rate adaptation.

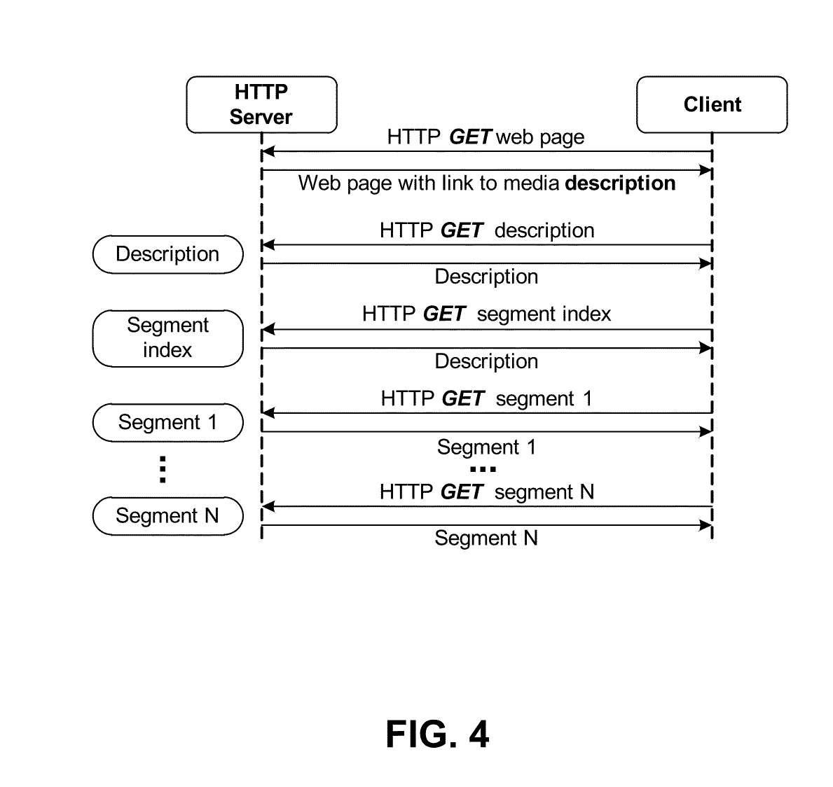

FIG. 4 is a diagram illustrating an example of a sequence of interactions between a streaming client and a HTTP server during a streaming session. For example, a description/manifest file, segment index files, and/or streaming segments may be obtained by the streaming client by means of HTTP GET requests. The description/manifest file may specify the types of encoded descriptions. Index files may provide location and/or timing information relating to the encoded segments.

Mobile operators may deploy TCP/HTTP proxy servers to perform caching, traffic shaping, and/or video transcoding operations. For example, such solutions may be effective for reducing the amounts of data coming in the form of video downloads (or progressive video downloads), but they may also affect streaming traffic. The differences between these solutions may include, for example, the degree of integration (single box vs multiple servers with dedicated functions, such as but not limited to caching, transcoding, DPI & video traffic detection/steering, and/or pacing) and/or the quality of transcoding that they provide. Some solutions may use techniques such as skipping of B frames, for example, whereas others may perform full transcoding.

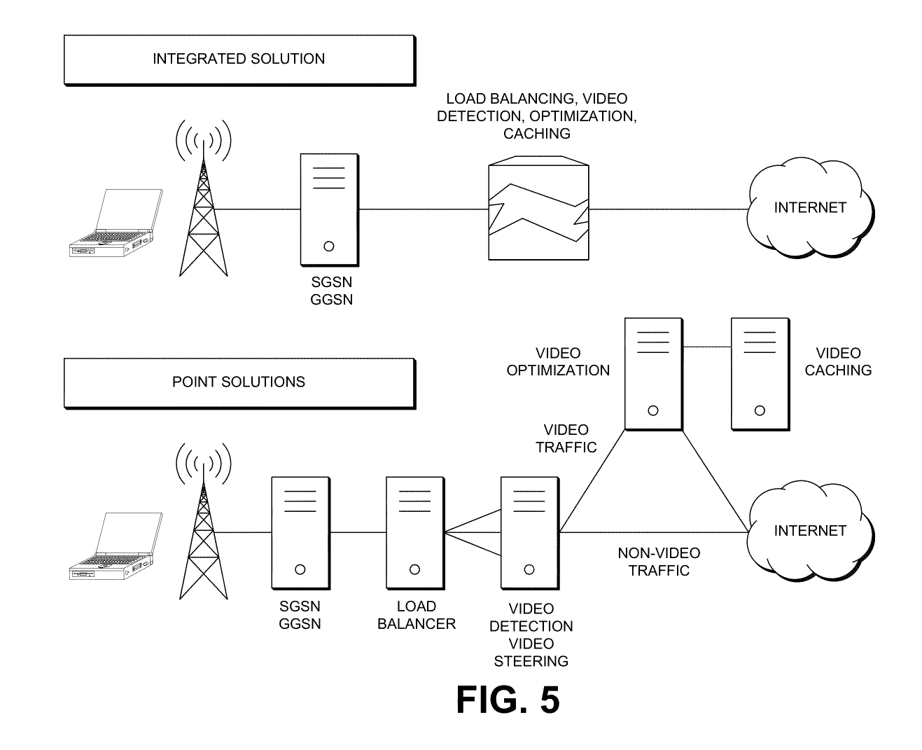

FIG. 5 is a diagram that illustrates an example of architectures and insertion points for such solutions in wireless communication systems.

Both adaptive streaming and transcoding solutions may solve problems that relate to, for example, the adaptation of the rate of an encoded stream to the available network bandwidth. Adaptive streaming may solve the problem in an end-to-end fashion, for example, allowing content owners to control fidelity of streams at different rates. Transcoders may solve the problem on-the-fly, for example, with stringent computational and/or time resources. Transcoders may solve the problem at quality levels that are worse than ones achievable by offline encoding (for example, multi-pass, originated from high-quality source, human-controlled encoding). For example, Transcoding of video from rate X to rate Y may be worse than direct encoding of same video to rate Y starting from a high quality source.

When applied to adaptive streaming content, transcoders may introduce one or more problems, such as but not limited to: (1) possible video stalls or even software crashes due to mis-prediction of network bandwidth by streaming client. For example, such bandwidth prediction logic may rely on “bandwidth” attributes of video streams declared in manifest (.mpd) files. If the actual amount of data received is much less, the client may choose to use higher-rate-encoded streams, for example; (2) the potential for degraded video quality due to receiving twice-encoded (transcoded) video instead of switching to the video that may be encoded at same rate; (3) possible oscillations between streams at different quality due to on/off transcoding or erratic stream switching caused by transcoding; (4) inefficient use of the backhaul network, and/or the entire network chain before transcoding proxy. For example, video may be sent over the entire network at 10 Mbps rate, and delivered to client at only 200 Kbps; and (5) confused analytics at the content publisher's site and/or CDN used to deliver the content.

For example, when content is cached, it may improve the access time and performance of the streaming system. However, incomplete segment-based caching may confuse rate adaptation logic in streaming clients. For example, if several prior segments were cached and were readily accessible without delays, the client may assume that this access rate is sustainable, and will schedule media data requests accordingly. However, if subsequent segments are not cached, this assumption may cause, for example, stalled video and rebuffering.

Described below are techniques that may be used in an adaptive HTTP streaming client to, for example, prevent network-level transcoding, detect that transcoding takes place and implement a custom reaction to it (such as, but not limited to, notifying user that s/he is not receiving original content), and/or adopt rate estimation and stream switching logic, which may produce meaningful decisions in the presence of caching and transcoding operations in the network.

A streaming client may employ a number of techniques to block or detect transcoding or random caching. One way to ensure secure delivery of original content may be for the streaming client to use a secure HTTP (HTTPS) connection to tunnel all exchanges between the streaming client and the server. This method may have certain overhead, for example in terms of delay and complexity. If the content is already protected by digital rights management (DRM), then it may not be useful to apply additional encryption. DRM-imposed encryption may be sufficient to block transcoding. DRM-imposed encryption may work if the content owner applies DRM to the content.

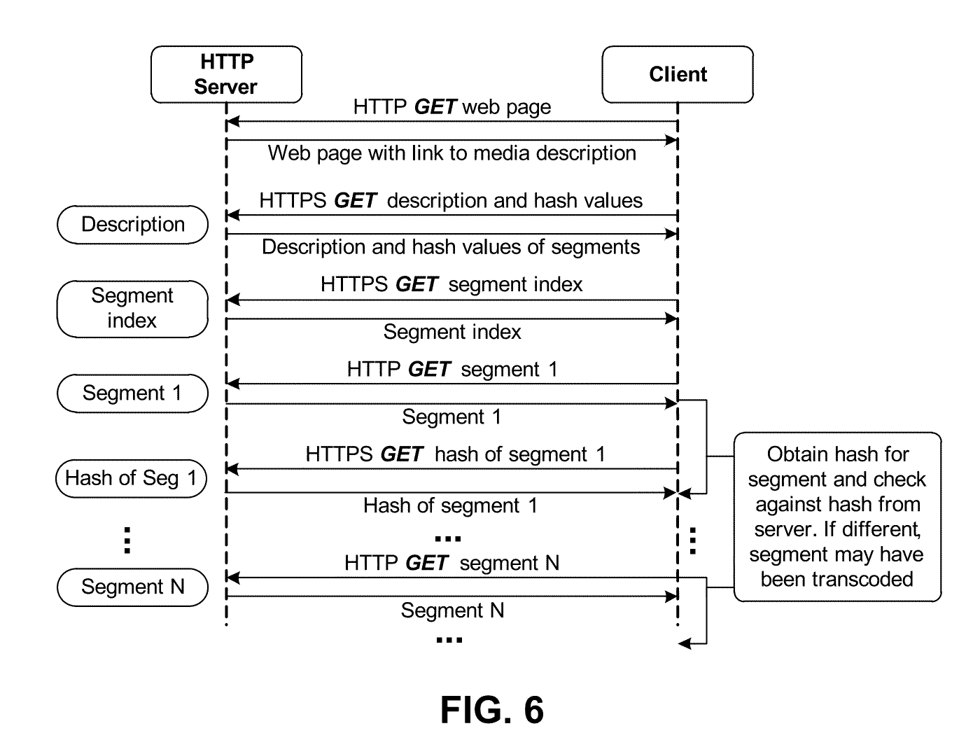

A MDP file may be augmented to refer to, for example, a MD5 or similar (or substantially similar) hash value of the encoded media segments. For example, the hash values of the encoded segments may be received in the description file or may be in a separate file that may be referenced by the description file. The streaming client may use HTTPS to obtain MDP file and files with hash values for each segment. The rest of data may be received over plain HTTP and/or received over HTTPS. The streaming client may check the hash values before decoding the content of each received segment. For example, the streaming client may check that the hash value of a received segment matches the hash value referred to by the description file. If authentication fails, the streaming client may, for example stop the operation and/or inform user. FIG. 6 is a flowchart of an example of the use of a technique that uses hashes to detect transcoding.

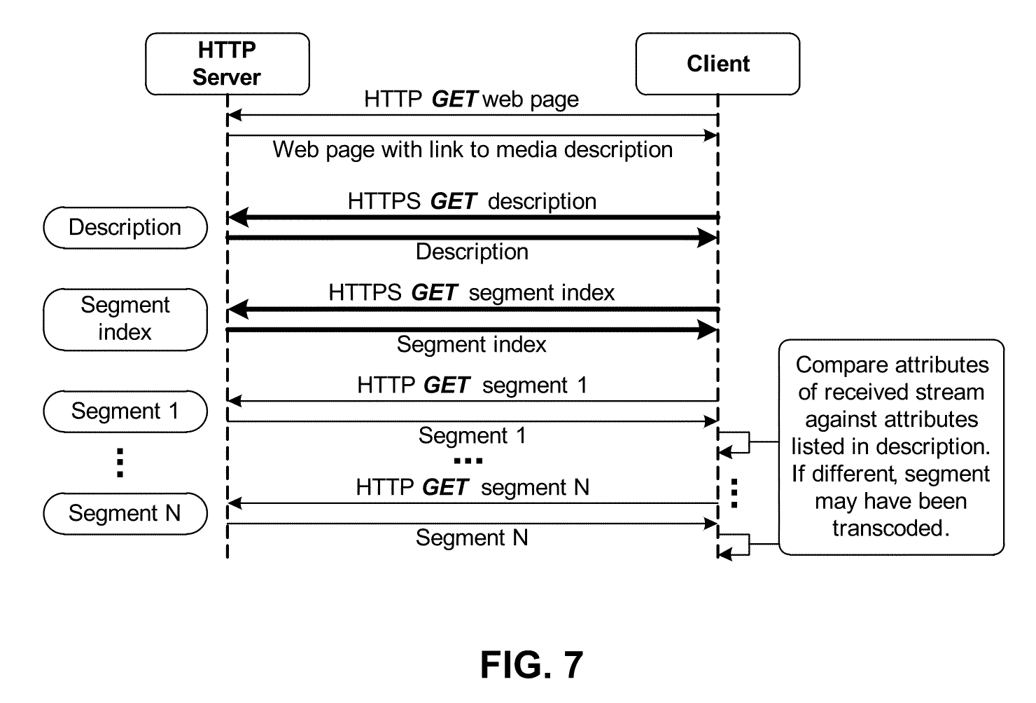

A streaming client may use HTTPS to retrieve MDP and/or index files that describe attributes of one or more encoded representation. Such attributes may include, but are not limited to, codec type & profile, image resolution, video frame resolution, and/or framerate. During a streaming session, the streaming client may check these attributes against attributes of actual delivered encoded streams. If the attributes do not match, then the streaming client may deduce that the stream was transcoded. FIG. 7 is a flowchart of an example of the use of a technique that uses stream attributes to detect transcoding.

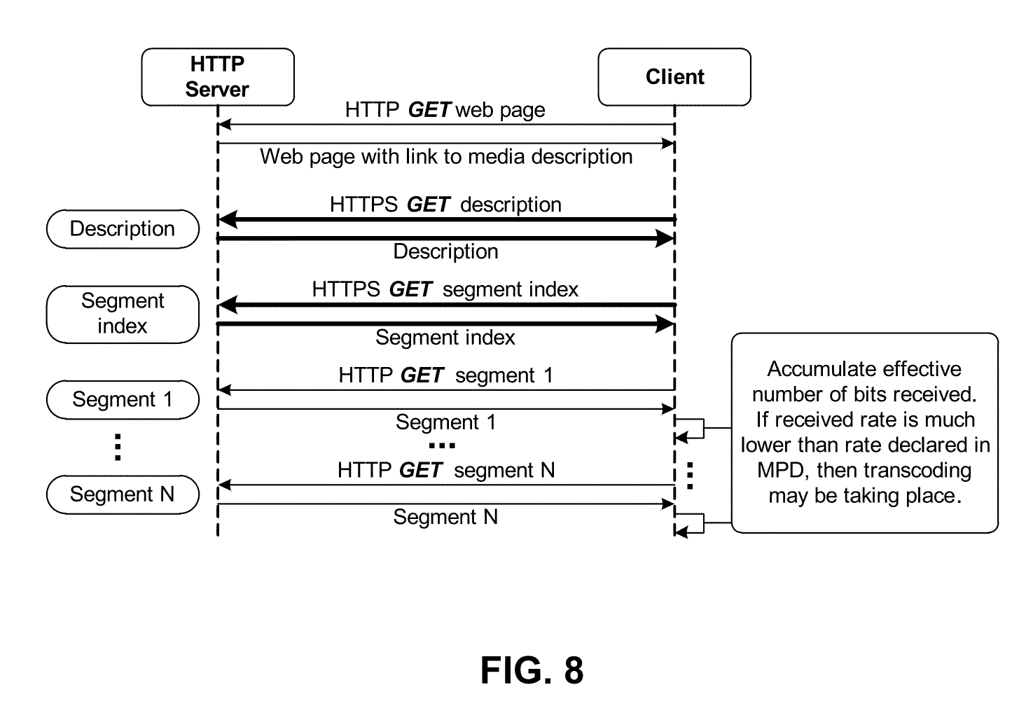

A streaming client may use HTTPS to retrieve a MDP file and/or the original intended bandwidth attributes of one or more encoded representation. The original intended bandwidth attributes may be part of the description file or in a separate file referred to by the description file. During a streaming session, the streaming client may accumulate an effective number of bits received and estimate an effective rate of each representation as it is received. If, after the client has received a reasonable number of segments (e.g. equivalent of 60 sec or more), the client notices that the rate the corresponding segment is less than it was declared in the MPD file (or below a particular threshold), the streaming client may deduce that transcoding is taking place. FIG. 8 is a flowchart of an example of the use of a technique that uses segment length check to detect transcoding.

In order to make it difficult for proxies to replace original data with transcoded content (e.g., reduce an amount of transcoding, reduce a likelihood of transcoding, and/or prevent transcoding), a streaming client may use split range-based HTTP GET requests to request segment data. For example, instead of issuing a single request to get an entire file (e.g., GET(path\segment_x.m4s)), a streaming client may issue one or more split requests that may specify one or more byte-ranges for data to be obtained, for example:
GET(bytes 1397 . . . 13298, of path\segment_x.m4s)
GET(bytes 0 . . . 1397, of path\segment_x.m4s)
   One or more embodiments contemplate partitioning a segment into one or more, or several, parts. In other words, more than one random boundary may be determined, for example two, three, or four random boundaries may be determined (among other amounts of random boundaries).

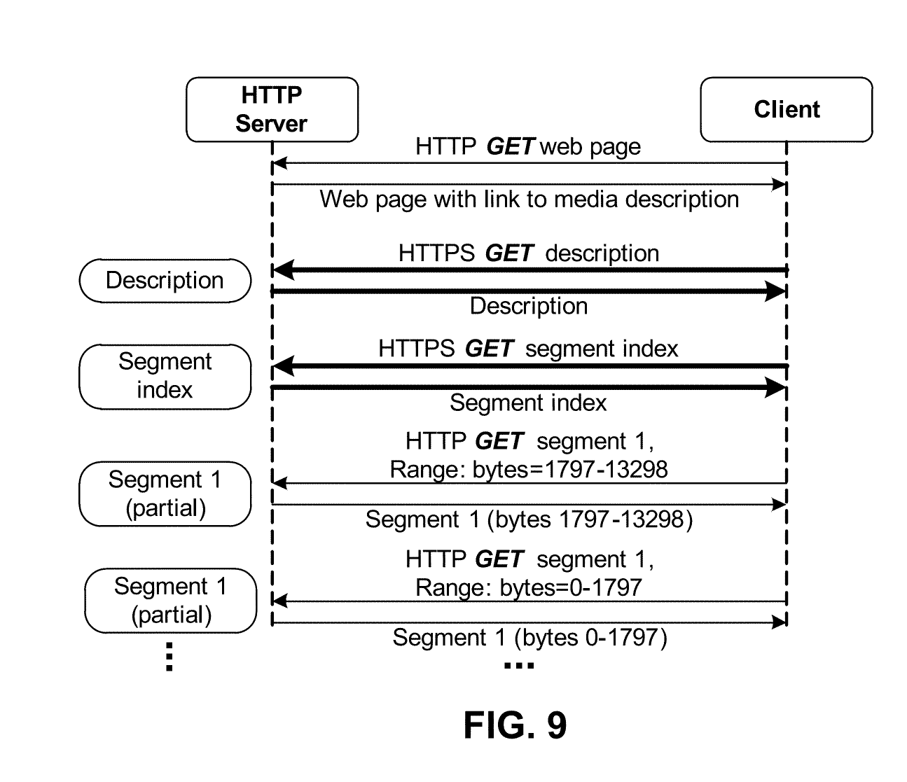

In order to make transcoding difficult, it may be sufficient to randomize the boundary between such requests. This technique may not affect the effectiveness of local caches. FIG. 9 is a flowchart of an example of the use of a technique that uses split-access to segment to deter transcoding.

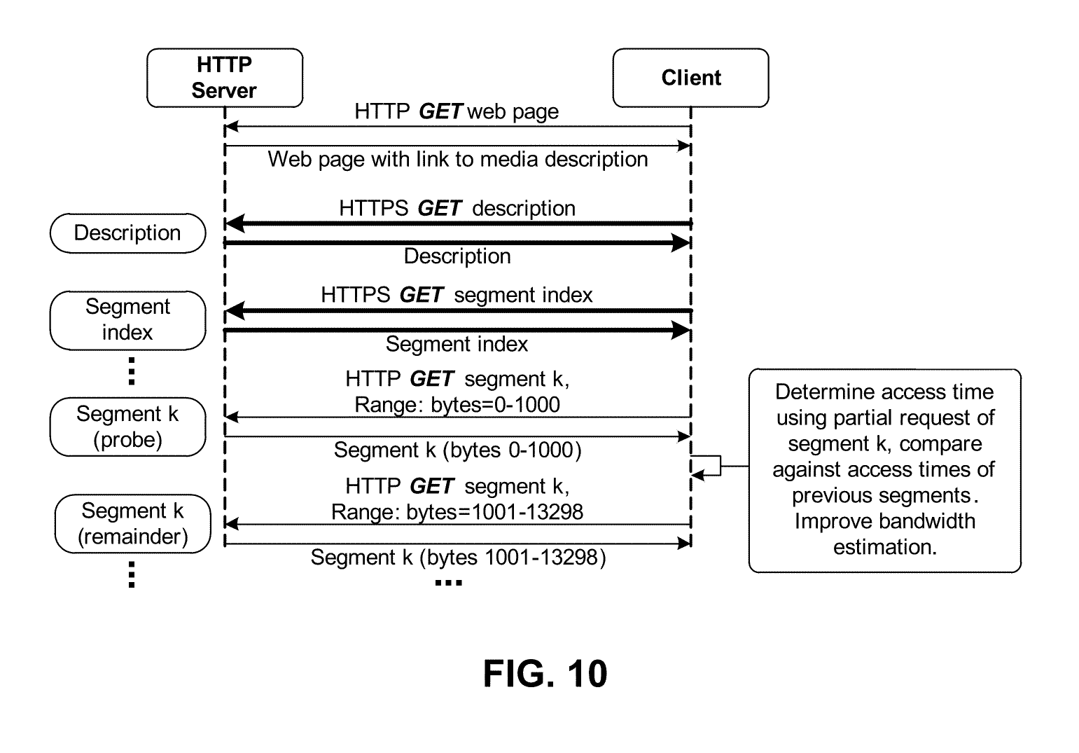

Split access may also be used to improve the accuracy of bandwidth sensing. For example, a streaming client may use a first partial GET request to probe the time it takes to access data from a new segment. This access time may be compared to the averaged access time for previous segments. If the probe request arrives with a larger delay, the streaming client may deduce that the segment is not cached, and therefore it may take more time to retrieve it compared to prior segments. FIG. 10 is a flowchart of an example of the use of a technique that uses split-access to segments to improve the accuracy of bandwidth estimation.

The streaming client may adopt any combination of the techniques described herein. Any combination of the techniques described herein may be used to ensure high quality of delivery in the presence of transcoding/caching entities in the network. A streaming client may use any combination of the techniques described herein. For example, a streaming client may use the following integrated logic: (1) Use HTTPS to get an MDP file; (2) If from MDP it follows that content is DRM'ed, the streaming client may continue receiving it without worrying about transcoding; (3) Else, if content is not encrypted, the streaming client may check if checksums (e.g., MD5 checksums) are supplied. If checksums are supplied, the streaming client may use the checksums to authenticate the content; and (4) Else, if there is no checksums, the streaming client may (4a) use split-requests to get more accurate estimates about bandwidth and/or to make transcoding less likely; and/or (b) perform checks of attributes and actual bandwidth usage, and if the streaming client detects anomalies, it may react appropriately.

For example, in a situation when a streaming client detects that it receives a transcoded stream, but it chooses to continue playback, the streaming client may switch the current stream to one more accurately matching the effective (after transcoding) rate of the incoming stream. By switching to a lower rate stream, the streaming client may minimize the chances that a lower-quality stream will also be transcoded. When the streaming client finds a stream with a rate that can be sustained by the network, the stream may be delivered without transcoding.

Dynamic Adaptive HTTP Streaming (DASH) is a standard that may consolidate several approaches for hypertext transfer (or transport) protocol (HTTP) streaming MPEG DASH may be an extension of “3GP-DASH.” DASH may be used to cope with variable bandwidth in wireless and wired networks and may be supported by content providers and devices. DASH may enable multimedia streaming services over any access network to any device.

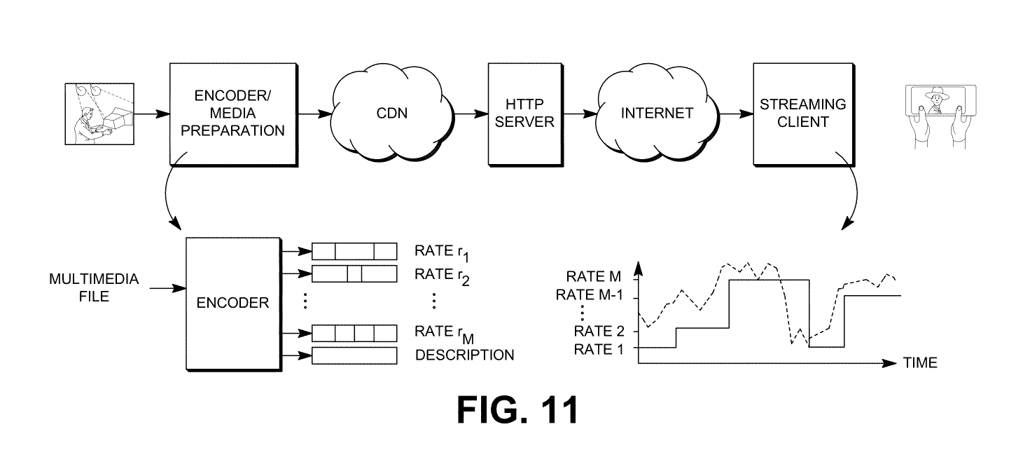

DASH may deploy as a set of HTTP servers that may distribute live and/or on-demand content that has been prepared in a suitable format. Clients may access content directly from these HTTP servers and/or from a Content Distribution Networks (CDN) as shown in the example of FIG. 11. CDNs may be used for deployments where a large number of clients are expected, as they may cache content and may be located near the clients at the edge of the network.

In DASH, the streaming session may be controlled by the client by requesting segments using HTTP and splicing them together as they are received from the content provider and/or CDN. Clients may continually monitor and adjust media rate based on network conditions (e.g., packet error rate, delay jitter) and their own state (e.g., buffer fullness, user behavior, preferences), effectively moving intelligence from the network to the clients.

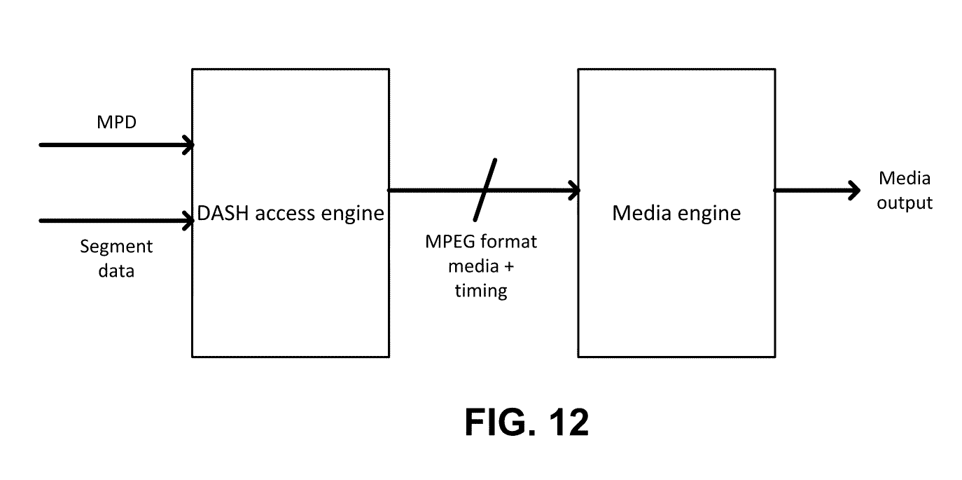

The DASH standard may be similar (or substantially similar) to informative client models. FIG. 12 is an example of the logical components of a conceptual DASH client model. The DASH Access Engine may receive the media presentation description file (MPD). The DASH Access Engine may construct and issue requests, and receive segments or parts of segments. The output of the DASH Access Engine may be consisting of media in MPEG container formats (MP4 File Format and/or MPEG-2 Transport Stream) together with timing information that maps the internal timing of the media to the timeline of the presentation. The combination of encoded chunks of media, together with timing information, may be sufficient for correct rendering of the content.

Some of the constraints that DASH imposes on encoded media segments are based on an assumption that decoding, post-processing, and/or playback may be done by a media engine that knows nothing about what those segments are and/or how they were delivered. The media engine may just decode and play a continuous media file, fed in chunks by the DASH access engine.

For example, the DASH access engine may be a Java script, while media engine may be something that is provided by a browser, a browser plugin (such as, but not limited to Flash or Silverlight), and/or operating system.

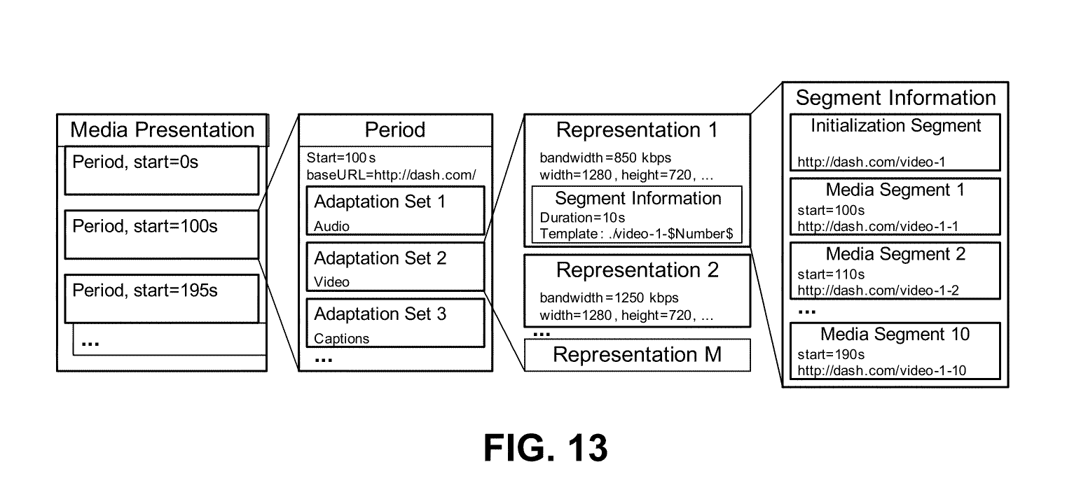

In DASH, the organization of a multimedia presentation may be based on a hierarchical data model as shown in the example of FIG. 13. Media Presentation Description (MPD) may describe the sequence of Periods that make up a DASH media presentation (i.e., the multimedia content). Period may represent a media content period during which a set of encoded versions of the media content is available. For example, the set of available bit rates, languages, and/or captions may not change during a Period.

An Adaptation Set may represent a set of interchangeable encoded versions of one or more media content components. For example, there may be an Adaptation Set for video, one for primary audio, one for secondary audio, and/or one for captions. The Adaptation Sets may be multiplexed, in which case, interchangeable versions of the multiplex may be described as a single Adaptation Set. For example, an Adaptation Set may contain both video and main audio for a Period.

A Representation may describe a deliverable encoded version of one or more media content components. A Representation may include one or more media streams (for example, one for each media content component in the multiplex). Any single Representation within an Adaptation Set may be sufficient to render the contained media content components. Clients may switch from Representation to Representation within an Adaptation Set in order to adapt to network conditions or other factors. Clients may ignore Representations that use codecs, profiles, and/or parameters that they do not support. Content within a Representation may be divided in time into Segments of fixed or variable length. A URL may be provided for each Segment. A Segment may be the largest unit of data that may be retrieved with a single HTTP request.

The Media Presentation Description (MPD) may be a XML document that contains metadata used by a DASH client to construct appropriate HTTP-URLs to access Segments and/or to provide the streaming service to the user. A Base URL in the MPD may be used by the client to generate HTTP GET for Segments and other resources in the Media Presentation. HTTP partial GET requests may be used to access a limited portion of a Segment by using a byte range (via the ‘Range’ HTTP header). Alternative base URLs may be specified to allow access to the presentation in case a location is unavailable, providing redundancy to the delivery of multimedia streams, allowing client-side load balancing, and/or parallel download.

An MPD may be ‘static’ or ‘dynamic’ in type. A static MPD type may or may not change during the Media Presentation, and may be used for on demand presentations. A dynamic MPD type may be updated during the Media Presentation, and may be used for live presentations. An MPD may be updated to extend the list of Segments for each Representation, introduce a new Period, and/or terminate the Media Presentation.

In DASH, encoded versions of different media content components (e.g., video, audio) may share a common timeline. The presentation time of access units within the media content may be mapped to a global common presentation timeline, referred to as a Media Presentation Timeline. This may allow synchronization of different media components and may enable seamless switching of different coded versions (i.e., Representations) of the same media components.

Segments may contain the actual segmented media streams. They may include additional information on how to map the media stream into the media presentation timeline for switching and/or synchronous presentation with other Representations.

The Segment Availability Timeline may be used to signal clients the availability time of segments at the specified HTTP URLs. For example, these times may be provided in wall-clock times. Before accessing the Segments at the specified HTTP URL, clients may compare the wall-clock time to Segment availability times. For on-demand content, the availability times of Segments may be identical. Segments of the Media Presentation may be available on the server once any Segment is available. The MPD may be a static document.

For live content, the availability times of Segments may depend on the position of the Segment in the Media Presentation Timeline. Segments may become available with time as the content is produced. The MPD may be updated periodically to reflect changes in the presentation over time. For example, Segment URLs for new segments may be added to the MPD. Old segments that are no longer available may be removed from the MPD. Updating the MPD may not be necessary if Segment URLs are described using a template.

The duration of a segment may represent the duration of the media contained in the Segment when presented at normal speed. Segments in a Representation may have the same or roughly similar (or substantially similar) duration. Segment duration may differ from Representation to Representation. A DASH presentation may be constructed with relative short segments (for example, a few seconds), or longer Segments including a single Segment for the whole Representation.

Short segments may be suitable for live content (for example, by reducing end-to-end latency) and may allow for high switching granularity at the Segment level. Small segments may increase the number of files in the presentation. Long segments may improve cache performance by reducing the number of files in the presentation. Long segments may enable clients to make flexible request sizes (for example, by using byte range requests). Long segments may make the use of Segment Index and may not be suitable for live events. Segments may or may not be extended over time. A Segment may be a complete and discrete unit that is made available in its entirety.

Segments may be further subdivided into Sub-segments. Each Sub-segment may contain a whole number of complete access units. An “access unit” may be a unit of a media stream with an assigned Media Presentation time. If a Segment is divided into Sub-segments, these may be described by a Segment Index. A Segment Index may provide the presentation time range in the Representation and corresponding byte range in the Segment occupied by each Sub-segment. Clients may download this index in advance and then issue requests for individual Sub-segments using, for example, HTTP partial GET requests. The Segment Index may be included in the Media Segment, for example, in the beginning of the file. Segment Index information may be provided in separate Index Segments.

DASH may define, for example, four types of segments, including but not limited to Initialization Segments, Media Segments, Index Segments, and Bitstream Switching Segments. Initialization Segments may contain initialization information for accessing the Representation. Initialization Segments may or may not contain media data with an assigned presentation time. Conceptually, the Initialization Segment may be processed by the client to initialize the media engines for enabling play-out of Media Segments of the containing Representation.

A Media Segment may contain and may encapsulate media streams that are either described within this Media Segment and/or described by the Initialization Segment of this Representation. Media Segments may contain a number of complete access units and may contain at least one Stream Access Point (SAP) for each contained media stream.

Index Segments may contain information that is related to Media Segments. Index Segments may contain indexing information for Media Segments. An Index Segment may provide information for one or more Media Segments. The Index Segment may be media format specific and more details may be defined for each media format that supports Index Segments.

A Bitstream Switching Segment may contain data for switching to the Representation it is assigned to. A Bitstream Switching Segment may be media format specific and more details may be defined for each media format that permits Bitstream Switching Segments. One bitstream switching segment may be defined for each Representation.

Clients may switch from Representation to Representation within an Adaptation Set at any point in the media. Switching at arbitrary positions may be complicated because of coding dependencies within Representations and other factors. Download of ‘overlapping’ data may be avoided (i.e. media for the same time period from multiple Representations). Switching may be simplest at a random access point in the new stream. DASH may define a codec-independent concept of Stream Access Point (SAP) and identify various types of Stream Access Points. A stream access point type may be communicated as one of the properties of the Adaptation Set (for example, assuming that all segments within adaptation set have same SAP types).

A Stream Access Point (SAP) may enable random access into a file container of media stream(s). A SAP may be a position in a container enabling playback of an identified media stream to be started using the information contained in the container starting from that position onwards and/or possible initialization data from other part(s) of the container and/or externally available.

TSAP may be the earliest presentation time of any access unit of the media stream such that all access units of the media stream with presentation time greater than or equal to the TSAP may be correctly decoded using data in the Bitstream starting at ISAP and no data before ISAP.

ISAP may be the greatest position in the bitstream such that access units of the media stream with presentation time greater than or equal to TSAP may be correctly decoded using the bitstream data starting at ISAP and with or without any data starting before ISAP.

ISAU may be the starting position in the bitstream of the latest access unit in decoding order within the media stream such that access units of the media stream with presentation time greater than or equal to TSAP can be correctly decoded using this latest access unit and access units following in decoding order and no access units earlier in decoding order.

TDEC may be the earliest presentation time of any access unit of the media stream that can be correctly decoded using data in the bitstream starting at ISAU and with or without any data starting before ISAU. TEPT may be the earliest presentation time of any access unit of the media stream starting at ISAU in the bitstream. TPTF may be the presentation time of the first access unit of the media stream in decoding order in the bitstream starting at ISAU.

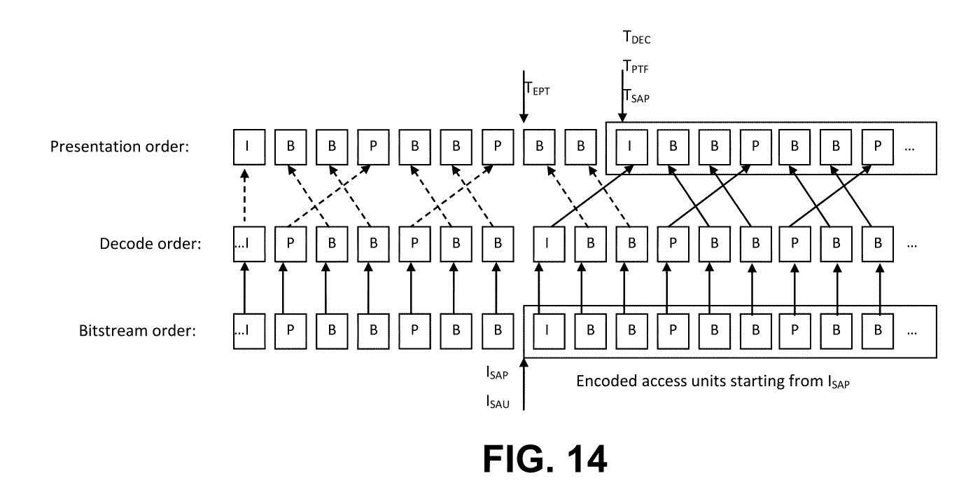

FIG. 14 is an example of a stream access point with parameters. FIG. 14 illustrates an encoded video stream with 3 different types of frames: I, P, and B. P-frames may find useful for (or in some embodiments may need only) prior I or P frames to be decoded, while B-frames may find useful (or in some embodiments may need) for both prior and following I and/or P frames. In some embodiments, there may be differences in transmission, decoding, and presentation orders in I, P, and/or B frames.

The type of SAP may be dependent on which Access Units are correctly decodable and/or their arrangement in presentation order. Examples of six SAP types are described below.

Type 1: TEPT=TDEC=TSAP=TPFT

SAP type 1 may correspond to what is known as a “Closed GoP random access point.” Access units (in decoding order) starting from ISAP may be correctly decoded. The result may be a continuous time sequence of correctly decoded access units with no gaps. The first access unit in decoding order may be the first access unit in presentation order.

Type 2: TEPT=TDEC=TSAP<TPFT

SAP type 2 may correspond to what is known as a “Closed GoP random access point” for which the first access unit in decoding order in the media stream starting from ISAU may not be the first access unit in presentation order. For example, the first two frames may be backward predicted P frames (which syntactically may be coded as forward-only B-frames in H.264 and some other codecs), and/or they may or may not find useful (or perhaps need) a 3rd frame to be decoded.

Type 3: TEPT<TDEC=TSAP<=TPTF

SAP type 3 may correspond to what is known as an “Open GoP random access point,” in which there may be some access units in decoding order following ISAU that may not be correctly decoded and/or may have presentation times less than TSAP.

Type 4: TEPT<=TPFT<TDEC=TSAP

SAP type 4 may correspond to what is known as a “Gradual Decoding Refresh (GDR) random access point,” (aka, “dirty” random access) in which there may be some access units in decoding order starting from and following ISAU that may not be correctly decoded and/or may have presentation times less than TSAP. One example case of GDR may be the intra refreshing process, which may be extended over N frames with part of frame coded with intra MBs. Non-overlapping parts may be intra coded across N frames. This process may be repeated until the entire frame is refreshed.

Type 5: TEPT=TDEC<TSAP

SAP type 5 may correspond to the case for which there is at least one access unit in decoding order starting from ISAP that may not be correctly decoded, may have a presentation time greater than TDEC, and/or where TDEC may be the earliest presentation time of any access unit starting from ISAU.

Type 6: TEPT<TDEC<TSAP

SAP type 6 may correspond to the case for which there may be at least one access unit in decoding order starting from ISAP that may not be correctly decoded, may have a presentation time greater than TDEC, and/or where TDEC may not be the earliest presentation time of any access unit starting from ISAU.

Profiles of DASH may be defined to enable interoperability and the signaling of the use of features. A profile may impose a set of restrictions. Those restrictions may be on features of the Media Presentation Description (MPD) document and/or on Segment formats. The restriction may be on content delivered within Segments, such as but not limited to on media content types, media format(s), codec(s), and/or protection formats, and/or on quantitative measures such as but not limited to bit rates, Segment durations and sizes, and/or horizontal and vertical visual presentation size.

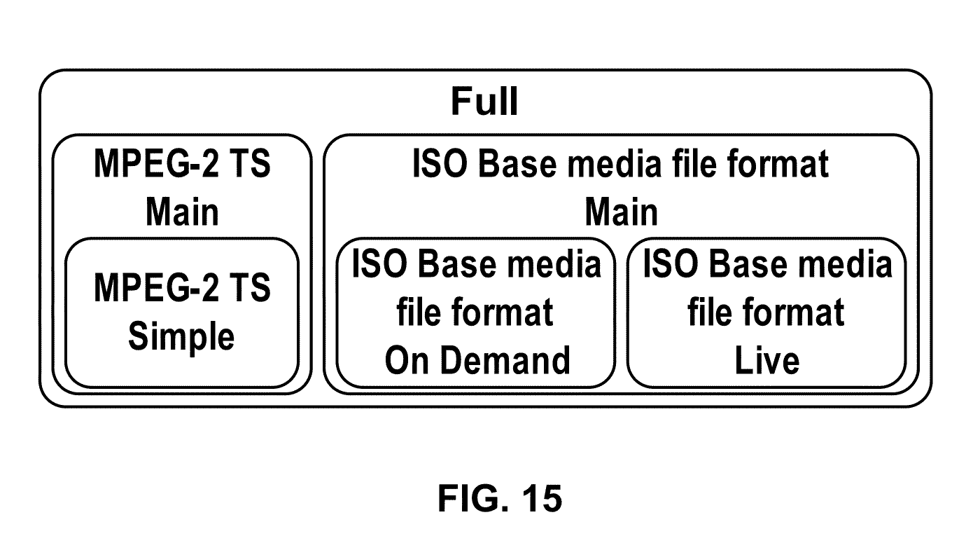

For example, DASH may define the six profiles shown in FIG. 15. Profiles may be organized in two major categories based on the type of file container used for segments. Three profiles may use ISO Base media file containers, two profiles may use MPEG-2 transport stream (TS) based file containers, and one profile may support both file containers types. Either container type may be codec independent.

The ISO Base media file format of the On Demand profile may provide basic support for on demand content. Constraints of the On Demand profile may be that each Representation may be provided as a single Segment, Subsegments may be aligned across Representations within an Adaptation Set, and/or Subsegments may begin with Stream Access Points. The On Demand profile may be used to support large VoD libraries with minimum amount of content management. The On Demand profile may permit scalable and efficient use of HTTP servers and may simplify seamless switching.

The ISO Base media file format Live profile may be optimized for live encoding and/or low latency delivery of Segments consisting of a single movie fragment of ISO file format with relatively short duration. Each movie fragment may be requested when available. This may be accomplished using a template generated URL. It may not be necessary to request a MPD update prior to each Segment request. Segments may be constrained so that they may be concatenated on Segment boundaries, and decrypted without gaps and/or overlaps in the media data. This may be regardless of adaptive switching of the Representations in an Adaptation Set. This profile may be used to distribute non-live content. For example, in case a live Media Presentation is has terminated, but kept available as On-Demand service. The ISO Base media file format Main profile may be a superset of the ISO Base media file format On Demand and Live profiles.

The MPEG-2 TS main profile may impose little constraint on the Media Segment format for MPEG-2 Transport Stream (TS) content. For example, representations may be multiplexed, so no binding of media streams (audio, video) at the client may be useful (or perhaps required). For example, Segments may contain an integer number of MPEG-2 TS packets. For example, Indexing and Segment alignment may be recommended. Apple's HLS content may be integrated with this profile by converting an HLS media presentation description (.m3u8) into a DASH MPD.

The MPEG-2 TS simple profile may be a subset of the MPEG-2 TS main profile. It may impose more restrictions on content encoding and multiplexing in order to allow simple implementation of seamless switching. Seamless switching may be achieved by guaranteeing that a media engine conforming to ISO/IEC 13818-1 (MPEG-2 Systems) can play any bitstream generated by concatenation of consecutive segments from any Representation within the same Adaptation Set. The Full profile may be a superset of the ISO Base media file format main profile and MPEG-2 TS main profile.

Embodiments recognize that Dynamic Adaptive Streaming over HTTP (DASH) is a multimedia streaming technology currently being developed under the Moving Picture Experts Group (MPEG). MPEG DASH standard (ISO/IEC 23009) defines a framework for design of bandwidth-adaptive multimedia streaming over wireless and wired networks. This standard defines one or more file formats and protocols to be used. Further, this standard defines conformance points. Embodiments contemplate that this standard may provide guidelines for design of DASH systems, focusing, in part, on design of DASH streaming client. Embodiments contemplate one or more techniques, systems, and/or architectures for improving DASH.

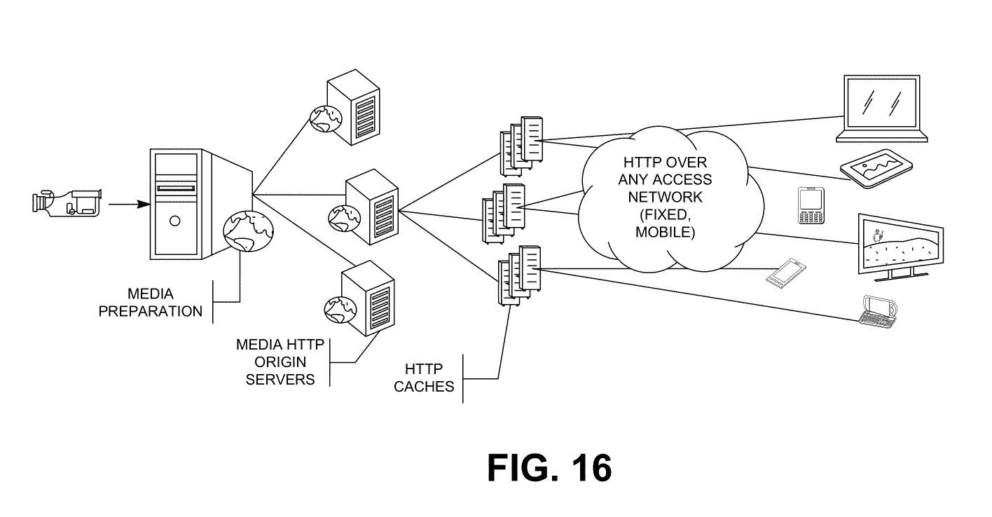

FIG. 16 illustrates a diagram of an example system for DASH-based multimedia delivery. The media encoding process may generate segments where one or more, or each, may include different encoded versions of one or more of the media components of the media content. One or more, or each, segment may include streams that may be used for decoding and displaying a time interval of the content. The segments may then be hosted on one or more media origin servers, perhaps along with a manifest, known as Media Presentation Description (MPD). The media origin server may be a plain HTTP server, perhaps in some embodiments conforming to RFC 2616, as any communication with the server may be HTTP-based. The MPD information may provide instructions on the location of segments and/or the timing and relation of the segments, e.g., how they may form a media presentation. Based on this information in MPD, a client may request the segments using HTTP GET and/or partial GET methods. The client may full control the streaming session, e.g., it may manage the on-time request and smooth playback of the sequence of segments, potentially adjusting bitrates or other attributes, e.g. to react to changes of the device state or the user preferences.

In one or more embodiments, massively scalable media distribution may use the availability of server farms to handle the connections to one or more, or all, individual clients. HTTP-based Content Distribution Networks (CDNs) may be used to serve Web content, and for offloading origin servers and/or reducing download latency. Such systems may include a distributed set of caching Web proxies and/or a set of request redirectors. Given the scale, coverage, and reliability of HTTP-based CDN systems in the existing Internet infrastructures, among other factors, it may be used for large scale video streaming services. This use can reduce the capital and operational expenses, and/or can reduce or eliminate decisions about resource provisioning on the nodes. This principle is indicated in FIG. 16 by the intermediate HTTP servers/caches/proxies. Scalability, reliability, and proximity to the user's location and high-availability may be provided by these general-purpose caches.

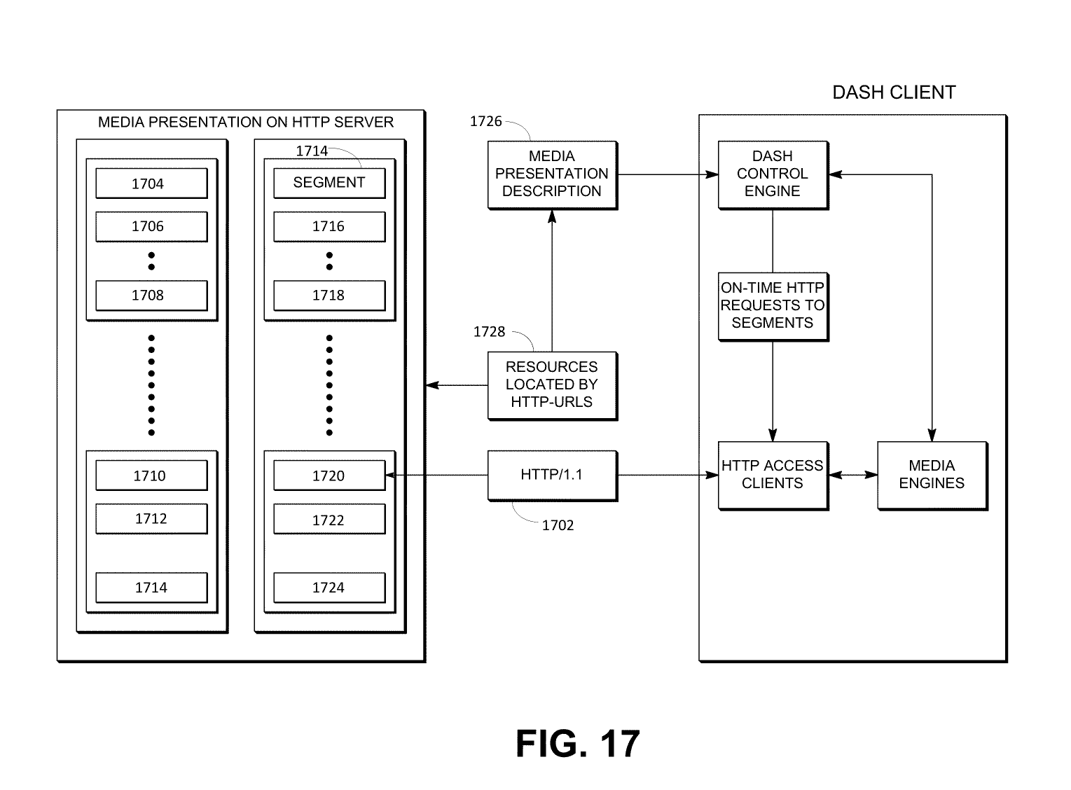

One or more embodiments recognize that the MPEG-DASH (or formally ISO/IEC 23009-1, incorporated by reference herein) specification may serve as an enabler for design of DASH. It may not specify a full end-to-end solution, but rather basic building blocks to enable it. Specifically, ISO/IEC 23009-1 defines two formats as shown in FIG. 17, which illustrates a diagram of standardized aspects in DASH. Particularly, the Media Presentation Description (MPD) describes a Media Presentation, e.g., a bounded or unbounded presentation of media content. In particular, it may define one or more formats to announce resource identifiers for Segments as HTTP-URLs and may provide the context for these identified resources within a Media Presentation. The Segment format may specify the format of the entity body of an HTTP response to an HTTP GET request or a partial HTTP GET, with the indicated byte range through HTTP/1.1 as defined in RFC 2616, to a resource identified in the MPD. These normative DASH components are shown as blocks 1704-1728 in FIG. 17. At block 1702, in some embodiments DASH assumes HTTP 1.1 interface between client and the server. In some embodiments, the rest of components may be assumed to be undefined and/or left to the implementation community to determine.

Embodiments recognize that ISO/IEC 23009-1 may include several informative components, explaining the intended use of MPD and/or segment formats in streaming delivery system. Specifically, with respect to functionality and expected behavior of DASH client, it provides the following: informative client model—defined in Clause 4.3 of ISO/IEC 23009-1; and example of DASH client behavior—defined in Annex A of ISO/IEC 23009-1. There is also an ongoing work on DASH Part 3 (ISO/IEC TR 23009-3: Implementation Guidelines), which may produce mode detailed explanation of DASH client behavior. Embodiments recognize examples of DASH client behaviour, such as those provided in Annex A of ISO/IEC 23009-1.

As an example of DASH client operation, a DASH client may be guided by the information provided in the MPD. The following example assumes that the MPD@type is ‘dynamic’. The behavior in case MPD@type being ‘static’ may be a subset of the description here. In one or more embodiments, the client may perform MPD parsing in which the client retrieves and parses the MPD, and may select a set of Adaptation Sets suitable for its environment, perhaps based on information provided in one or more, or each, of the AdaptationSet elements. The selection of Adaptation Sets may also take into account information provided by the AdaptationSet@group attribute and/or any constraints of a possibly present Subset element. Further, the client may implement rate/representation selection where within each Adaptation Set it selects at least one specific Representation, perhaps based on the value of the @bandwidth attribute, and in some embodiments perhaps also taking into account client decoding and rendering capabilities. Then it may create a list of accessible Segments for one or more, or each, Representation for the actual client-local time NOW measured in wall-clock time taking into account one or more procedures. Subsequently, the client may implement segment retrieval where the client may access the content by requesting entire Segments or byte ranges of Segments. The client may request Media Segments of the selected Representation by using the generated Segment list. Subsequently, the client may implement buffering and playback where the client buffers media of for at least value of @minBufferTime attribute duration before starting the presentation. Then, perhaps after it may have identified a Stream Access Point (SAP) for one or more, or each, of the media streams in the different Representations, it may start rendering (in wall-clock-time) of this SAP, perhaps not before MPD@availabilityStartTime+PeriodStart+T_{SAP} and perhaps not after MPD@availabilityStartTime+PeriodStart+T_{SAP}+@timeShiftBufferDepth and perhaps provided the observed throughput may remain at or above the sum of the @bandwidth attributes of the selected Representations (e.g., if not, longer buffering may be useful).

For services with MPD@type=‘dynamic’, rendering the SAP at the sum of MPD@availabilityStartTime+PeriodStart+T_{SAP} and the value of MPD@suggestedPresentationDelay may be useful, perhaps if synchronized play-out with other devices adhering to the same rule may be desired, among other reasons. Subsequently, the client may implement continued playback and segment retrieval/stream switching where once the presentation has started, the client may continue consuming the media content by continuously requesting Media Segments or parts of Media Segments. The client may switch Representations taking into account updated MPD information and/or updated information from its environment, e.g., change of observed throughput. With any request for a Media Segment including a stream access point, the client may switch to a different Representation. Seamless switching can be achieved, as the different Representations may be time-aligned. Advantageous switching points may announce in the MPD and/or in the Segment Index, if provided. Subsequently, the client may implement live streaming/decision when to fetch new MPD in which with the wall-clock time NOW advancing, the client may consume the available Segments. As NOW advances the client possibly may expand the list of available Segments for one or more, or each, Representation according to the procedures specified in A.3 of ISO/IEC 23009-1.

In some embodiments, perhaps if one or more of the following may both be true, among other reasons, an updated MPD may be fetched: (1) The @mediaPresentationDuration attribute is not declared, or if any media described in the MPD does not reach to the end of the Media Presentation; and (2) the current playback time gets within a threshold (typically described by at least the sum of the value of the @minBufferTime attribute and the value of the @duration attribute (or the equivalent value in case the SegmentTimeline may be used) of the media described in the MPD for any consuming or to be consumed Representation. If the clauses are true, among other reasons, the client can fetch a new MPD, and/or update FetchTime. Once received the client takes into account the possibly updated MPD and the new FetchTime in the regeneration of the accessible Segment list for one or more, or each, Representation.

One or more embodiments may assume that the client may have access to the MPD at time FetchTime, at its initial location if no MPD.Location element is present, or at a location specified in any present MPD.Location element. In some embodiments, FetchTime may be defined as the time at which the server processes the request for the MPD from the client. The client may not use the time at which it may have successfully received the MPD, but may take into account delay due to MPD delivery and processing. The fetch may be considered successful fetching if the client obtains an updated MPD and/or the client verifies that the MPD has not been updated since the previous fetching.

In view of the aforementioned (as well as other parts of the DASH standard), in one or more embodiments, the DASH client may be configured to perform at least one or more of the following functions: access to HTTP server; reading & parsing MPD; reading/generating Segment Lists; reading/maintaining cache of Index Segments; reading Segments or Sub-Segments; selecting Subset and Adaptation Set to use; selecting initial representation and buffering; continuous playback logic/rate adaptation; support for trick modes; seeking; and/or stream switching.

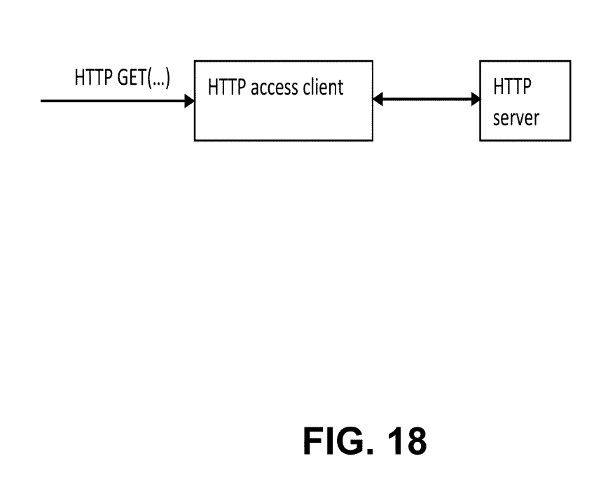

In some embodiments, perhaps in order to read MPD files and/or segments (by way of HTTP GET instructions), among other reasons, the DASH client may have a module that communicates to the HTTP server. By way of explanation, and not limitation, it may be referred to as an HTTP access module. FIG. 18 illustrates a block diagram of an example HTTP access module according to one or more embodiments. In some embodiments, perhaps when used for reading of sequences of media segments, among other scenarios, the HTTP client may operate in persistent HTTP connection mode in order to minimize latencies/overhead, for example.

In one or more embodiments, an MPD file can be read by the same or similar (or substantially similar) techniques as any other file on a web server. The same or similar (or substantially similar) HTTP access module can be used to load it. In some embodiments, it may be useful to use secure HTTP (HTTPS), perhaps instead of plain HTTP to retrieve it. One or more reasons for using HTTPS may include, but are not limited to: prevention of men-in-the-middle-type of attacks; carriage and usage of authentication information stored within the MPD file; and/or carriage and usage of encryption—related information, stored within an MPD file. Embodiments contemplate that HTTPS may (or sometimes) be used for reading of MPD files, but perhaps in some embodiments not media files/segments. In some embodiments, using HTTPS for entire streaming session(s) may diminish effectiveness of CDNs.

In order to implement MPD parsing, among other reasons, the client may use an MPD parsing module. This module can receive an MPD file, and/or produce a data structure including the following: a list of Periods in the presentation; for one or more, or each, Period—a list of available Subsets of Adaptation Sets, with mappings to media component types, roles, and other content properties (e.g. as communicated through descriptors); for one or more, or each, Adaptation Set—a list of available Representations; for one or more, or each Representation—a list of available Sub-Representation, if any; and/or for one or more, or each, Adaptation Set, Representation and Sub-Representations—their respective properties and/or attributes.

In generating this structure, the MPD reading module can parse and/or process information from DASH descriptors (such as but not limited to content protection, role, accessibility, rating, viewpoint, frame-packing, and/or audio channel configuration) and/or additional custom descriptors that may be identified by their respective URIs and schemas in related MPEG or external specifications.

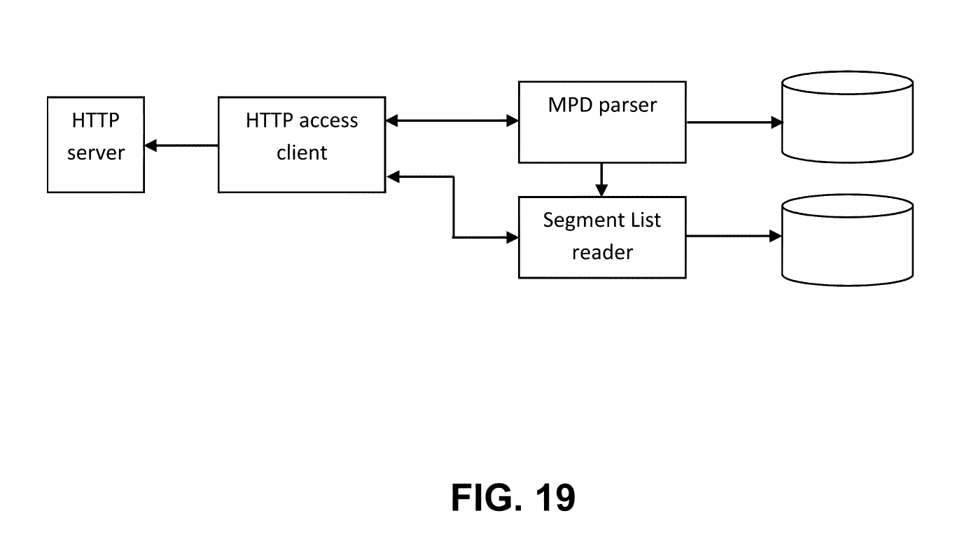

The MPD file may also include segment list or point to files including compact Index Segment boxes. In order to read segment list information, among other reasons, the client may employ a dedicated module for reading and/or generating such lists. FIG. 19 illustrates a block diagram of example MPD and segment list reading modules according to one or more embodiments. In one or more embodiments, an overall architecture of MPD parsing module may be as indicated in the configuration shown in FIG. 19.

Embodiments recognize that the DASH standard may define several alternative ways of describing the Segment List. This may accommodate bitstreams generated by several existing systems (such as Microsoft Smooth Streaming, Adobe Flash, and Apple HLS), and perhaps not because one way or the other may have any technical benefits. Specifically, a segment list for a Representation or Sub-Representation can be specified by one or more of: SegmentBase element, which may be used when a single media Segment may be provided for an entire Representation; SegmentList elements, perhaps providing a set of explicit URL(s) for Media Segments; and/or SegmentTemplate element, perhaps providing a template form of URL(s) for Media Segments.

In some embodiments, perhaps regardless of the method of description adopted, the information that can be extracted by the segment list parsing module may be expressed by one or more aspects. For example, an initialization segment, may or may not be present, and if present may be expressed by its URL (including possibly byte-range). In other words, the initialization segment may be part of a file that may contain initialization and/or segments. In such scenarios, a byte range HTTP request may be used to access the initialization segment. For media segments: a list may include for one or more, or each, segment one or more of the following information: Segment URL (including possibly byte-ranges), and/or Media Segment start time or duration. Start times and durations may be connected as: Duration[i]=MediaSegment[i+1].StartTime−MediaSegment[i].StartTime, so in some embodiments it may be sufficient to indicate either one. For some media segments it may also be useful to know if they start with SAP, or a type of SAP (and/or possibly SAP parameters—such as SAP_delta_time). Regarding index segments, they may or may not be present, and if present, URLs (including possibly byte-ranges) may be provided for each corresponding MediaSegment.

Embodiments recognize one or more exemplary algorithms for the generation of Segment list based on template or play-list representation are provided in ISO/IEC 23009-1, Clauses A.3.2-A.3.4, for example. Embodiments also recognize that ISO/IEC 23009-1 does not recite that in principle Index Segments may also be pre-loaded after streaming starts, and/or loaded in an on-demand fashion during playback, and/or that they may be available one or more times, or each time, the client may consider switching from one representation to another. As described herein, embodiments contemplate one or more techniques for the handling of index segments.

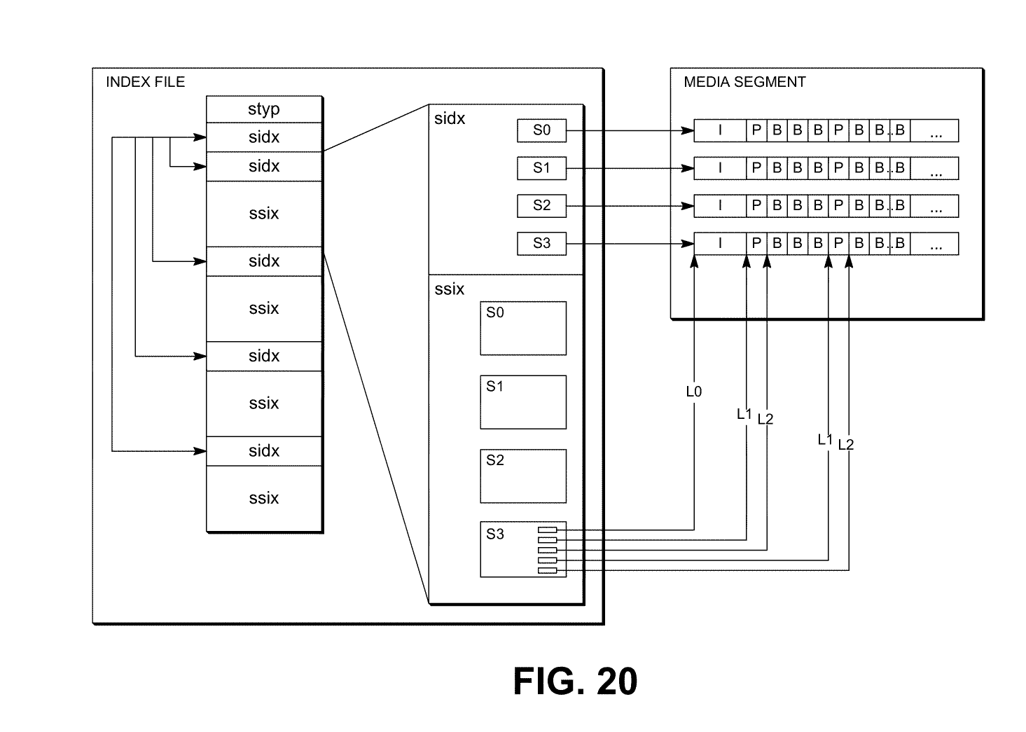

In one or more embodiments, Index Segments may include lists of their sub-segments and/or their parameters, presented as sequence of styp, sidx, and ssix boxes in ISO based media file format (ISOBMFF). ISOBMFF may include an index of one or more, or all, segments in Representation, and this may be used, for example, when used for indexing segments in MP2TS stream. FIG. 20 illustrates a block diagram of an example structure of a representation index segment. It the example of FIG. 20, one or more sidx boxes may define list(s) of sub-segments, and one or more ssix boxes may define byte-ranges and/or locations of where they can be found in the stream. In some embodiments, one or more ssix boxes may have capabilities for structuring access in temporal “layers,” which may be useful for implementing trick modes, for example.

In some embodiments, perhaps if sub-segments may structured such that they are temporally aligned and have consistent SAPs across (e.g., as may be indicated by @SubsegmentAlignment and @SubsegmentStartsWithSAP attributes in MDP), then implementation of stream-switching on a sub-segment level may be done. For example, in some embodiments a DASH client may be download to sidx boxes for one or more, or all, relevant representations before it can implement a switch. Embodiments contemplate one or more ways a DASH client can do so: maintain preloaded Segment Indices for one or more, or all, Representations within a chosen Adaptation Set at least up to duration specified by @minBufferTime; have a scheme, where Segment Indices from neighboring Representations are loaded in on-demand mode, for example sometime (or in some embodiments only) when client is considering a switch to corresponding Representation; and/or have a scheme that dynamically decides how many Segment Indices/Representations to consider based on factors such as, but not limited to, variability of channel rate, and/or variability of rates of encoded content within one or more, or each, representation.

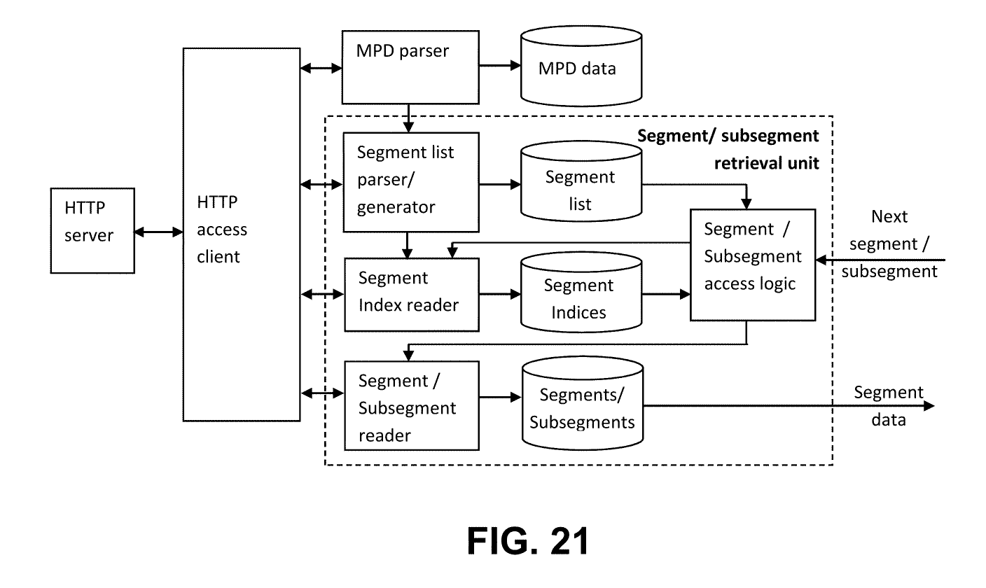

In one or more embodiments, the client may maintain a list/queue of one or more, or all, relevant Segment Indices, and may load them, perhaps before it can access sub-segments. An example of this logic is depicted in FIG. 21, which illustrates a block diagram of elements of an example architecture of DASH client, including MPD, Segment List, and Segment Index loading modules. In FIG. 21, the “Segment/subsegment retrieval unit” may use the “segment/subsegment access logic” to check the presence of the requested segment or subsegment in the segment list and/or segment index. In some embodiments, the index segments may be downloaded and placed into a local store. When one or more, or all, parameters of segment/subsegment are known, among other scenarios, —the control may be passed to the Segment/subsegment reader, which may translate it to HTTP GET requests to the server. The buffers with loaded segment lists and/or segment indices may include data relevant to one, some, several, or all Representations in a selected Adaptation set.

In selecting which adaptation sets to use, a DASH client may first establish relationships between present Adaptation Sets and Content Components. If Subsets are present—this may be done (or in some embodiments perhaps should be done) for one or more, or all, Adaptation Sets included in one or more, or each, Subset. One or more, or each, Adaptation Set may be associated with at least one content type (e.g. audio or video), which may be understood from either (e.g., @mimeType, @codecs, or @contentType attributes, or based on <ContentComponent . . . /> element).

In one or more embodiments, an Adaptation Set also may include one or more Representations that may embed multiple Content Components. Such Representations may also include SubRepresentations elements that may allow separate access to individual components. In some embodiments, SubRepresentations may also be there for some other reasons, for example to enable fast-forward operations. In some embodiments, SubRepresentations may also embed multiple Content Components.

In one or more embodiments, perhaps regardless of the arrangement, the DASH client may identify one or more of: which content components are present in the presentation; their availability in one or more, or each, Adaptation Set; unique properties or parameter ranges for one or more, or each, component as may be defined by adaptation sets (for example, for video: 2D vs 3D, resolution (width×height), codecs/profiles, etc.; for audio: role/language, # of channels, channel configuration, sampling rates, codecs, audio types, etc.; for one or more, or all, types: @bandwidth ranges). In some embodiments @mimeType, or @codecs attributes may be useful and/or mandatory, while other attributes may not be present. In some embodiments, perhaps based on the above information and one or more of the device capabilities, such as: decoding capabilities (support for codecs @ given profiles/levels); rendering capabilities (screen resolution, 3D support, form factor, screen orientation, etc.); network/connection capabilities (type of network (e.g. 3G/4G/802.11x/LAN), and its expected speed); battery/power status, etc.; and/or user selected preferences (e.g. for language, limits on data usage, etc.), the client may decide which Adaptation Set to use.

In some embodiments, one or more, or many, Adaptation Set properties may not be explicitly defined as attributes or descriptors within Adaptation Set elements. In order to properly collect (and/or verify) such information, the client may also scan properties of Representations included in corresponding Adaptation Sets.

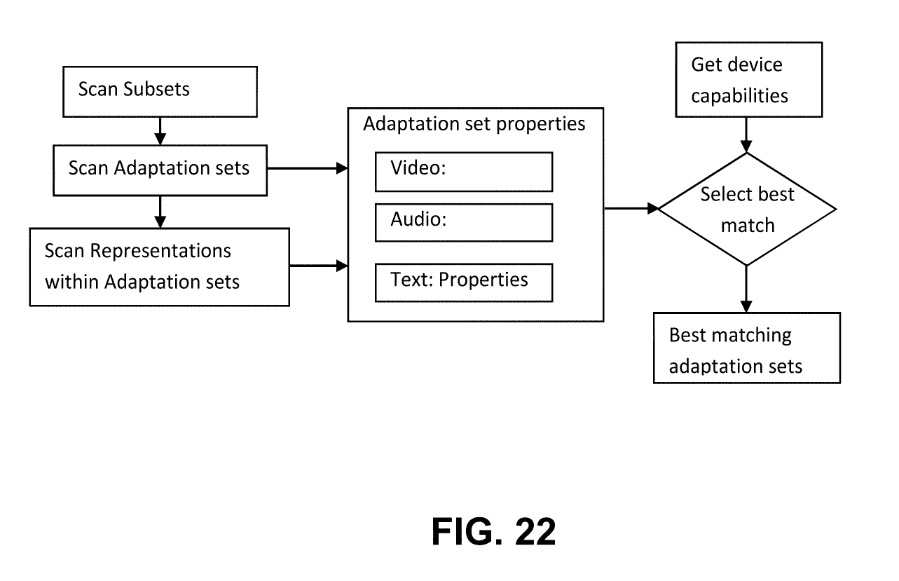

FIG. 22 illustrates a flow chart of example Adaptation Set selection logic. In some embodiments, advanced DASH client implementations may use multiple Adaptation Sets, and/or implement stream switching to cross from one Adaptation Set to another. For example, this may be useful perhaps when Adaptation Sets provided in MPD may have narrow ranges of bitrates, e.g., restricted to a particular codec/resolution, and a client may switch to a significantly different rate in order to be able to sustain real-time playback (e.g., avoid re-buffering). Clients that chose to use such switches may also have one or more techniques for achieving seamless transitions, for example, by using overlapped loading, and cross-fading between decoded segments.

In one or more embodiments, it may be assumed that DASH client may have already selected Adaptation Sets, but it still may select initial Representation and/or start playback. There may be at least two possible buffering modes that a DASH client can adopt: continuously buffer entire presentation from start to NOW (this may allow seek back and rewind operations, and this mode may also be used to convert streaming content to a locally stored file); and/or buffer segments with some bounded horizon—for example to maintain real-time playback and achieve robustness against network changes.

In one or more embodiments, the initial buffering that player may be performed before starting playback, may be at least to accumulate @minBufferTime of playback time, as may be specified in DASH MPD file. In some embodiments, the actual buffering time may depend on: network bandwidth; and/or rate (@bandwidth attribute) of the initial Representation selected for buffering.

In one or more embodiments, the client may use various hints to select the initial rate/Representation to use. For example, it may select the lowest rate Representation available (including, possibly picking Adaptation Set with such lowest-rate content present). This may be the guaranteed fastest start-up, but quality-wise it may be questionable, for example. In another example, it may select representation based on user-provided information about which initial rate to pick. In some embodiments, this may override other modes. In another example, it may select representation based on information about connection type and state of the network. Such information can be accessible, e.g. by way of OMA APIs, or network-related APIs that may be provided by the client device's OS. In another example, it may select representation based on information about speed of the network measured empirically, e.g. as a result of loading MPD, or probing downloading part of first segment. In another example, it may select representation based on information about speed of the network measured during previous streaming session. And also for example it may, by using a combination of above inputs, determine a most likely speed of the network.

In one or more embodiments, once Adaptation Set/Representation may be selected, the player may perform successive buffering of a segment(s) until their cumulative playback time reaches @minBufferTime attribute. Then, once it may have identified a Stream Access Point (SAP) for one or more, or each, of the media streams in the different Representations, it may start rendering (in wall-clock-time) of this SAP, perhaps not before MPD@availabilityStartTime+PeriodStart+TSAP and perhaps not after MPD@availabilityStartTime+PeriodStart+TSAP+@timeShiftBufferDepth, perhaps provided the observed throughput may remain at or above the sum of the @bandwidth attributes of the selected Representations (if not, longer buffering may be useful). For services with MPD@type=‘dynamic’, rendering the SAP at the sum of MPD@availabilityStartTime+PeriodStart+TSAP and the value of MPD@suggestedPresentationDelay may be useful, perhaps especially if synchronized play-out with other devices adhering to the same rule may be desired.

When designing rate adaptation algorithm for DASH, one or more embodiments contemplate that: @bandwidth attributes may not provide accurate information about rate at which one or more, or each segment may be encoded. In such scenarios, rate estimation may be based on information in segment index files, and/or actual length values returned by processing of HTTP GET requests.

One or more embodiments may take into account one or more of the following considerations: that the rate adaptation algorithm may efficiently utilize the sharable network capacities, which may affect playback media quality; that the rate adaptation algorithm may be capable of detecting network congestion and may be able to react promptly to prevent playback interruption; that the rate adaptation algorithm can provide stable playback quality, perhaps even if the network delivery capacities fluctuate widely and frequently; that the rate adaptation algorithm may be able to tradeoff maximum instantaneous quality and smooth continuous quality, for example by smoothing short-term fluctuation in the network delivery capacities by using buffering, but still may switch to better presentation quality/higher bitrates if more long-term bandwidth increase is observed, among other scenarios; and/or that the rate adaptation algorithm may be able to avoid excessive bandwidth consumption due to over-buffering media data.

In some embodiments, perhaps when implementing rate adaptation in DASH, among other scenarios, a balance may be made between different criteria listed above to improve the overall Quality of Experience (QoE) perceived by the user. In absence of other information, e.g., from the radio network status, the measurement for certain QoE metrics may be used in rate adaptation in DASH, e.g., average throughput: average throughput measured by a client in a certain measurement interval; and/or Segment Fetch Time (SFT) ratio (the ratio of Media Segment Duration (MSD) divided by SFT. MSD and SFT may denote the media playback time included in the media segment and/or the period of time from the time instant of sending a HTTP GET request for the media segment) to the instant of receiving the last bit of the requested media segment, respectively; and/or buffer level (buffered media time at a client).

In some embodiments, perhaps in cases when a client considers switching between representations including one or more of the following: have significant gap in bitrate; have different resolutions or sampling rates; use different codecs/profiles or audio types; or other factors that may introduce discontinuities or have diminishing effect on user experience, the client may consider using signal processing techniques to smooth such transitions. For example, this can be done by downloading overlapping segments, decoding audio or video content and then cross-fading the results prior to playback.

Regarding architecture of an example DASH client, in some embodiments a DASH client may be implemented, for example, as one or more of a stand-alone application, a component within the Internet browser or another application, a java-script embedded in a web-page, or an embedded software component in a set-top box, TV set, game console, and/or the like. In such scenarios, it may include all or some of the functionalities described herein.

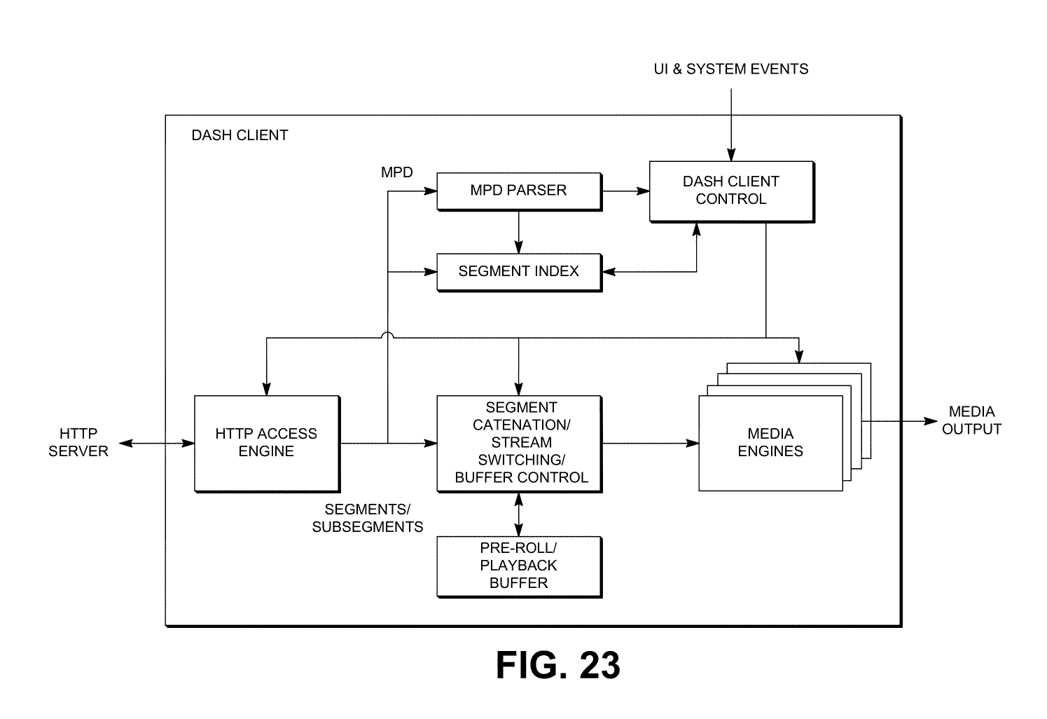

FIG. 23 illustrates a block diagram of an example overall top-down design of DASH client according to one or more embodiments. In FIG. 23, the client control engine may receive user commands, such as “play”, “pause”, or “seek” from an application and may translate them into appropriate actions of the DASH client. The HTTP access engine may issue requests to HTTP server to receive the Media Presentation Description (MPD) and/or Segments and/or Subsegments. The MPD parser may analyze the MPD file. The segment catenation/buffer control unit may receive incoming Segments or Subsegments, place them into a buffer, and/or schedule them to be delivered to the media playback engine. The actual rendering and playback of multimedia data may be accomplished by one or more Media Engines. The functionality of one or more, or each, building block may follow the functionality as described herein.

Although features and elements are described above in particular combinations, one of ordinary skill in the art will appreciate that each feature or element can be used alone or in any combination with the other features and elements. Further, the processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A method of bandwidth adaptive streaming in a wireless transmit/receive unit (WTRU) comprising:
receiving a description file from at least one network node using secure hypertext transport protocol (HTTPS), the description file comprising hash values of encoded media segments;
receiving an encoded media segment from the network node, the encoded media segment comprising a hash value;
determining if the hash value of the encoded video segment is substantially similar to a corresponding hash value of the description file; and
decoding the encoded media segment upon the hash value of the encoded video segment being substantially similar to the corresponding hash value of the description file.

2. The method of claim 1 further comprising:
ceasing reception of additional encoded media segments upon the hash value of the encoded video segment being not substantially similar to the corresponding hash value of the description file.

3. The method of claim 1, further comprising:
receiving an index file from the at least one network node using secure HTTP (HTTPS), the index file comprising attributes of one or more encoded representations;
receiving encoded content via streaming content from a network;
determining if the attributes of the index file are substantially similar to attributes of the received encoded content during the streaming content from the network; and
determining that the received encoded content was transcoded upon the attributes of the index file not being substantially similar to the attributes of received encoded content.

4. The method of claim 3, wherein the attributes comprise at least one of codec type, profile, video frame resolution, or frame rate.

5. The method of claim 1, further comprising:
receiving one or more intended bandwidth attributes of one or more encoded representations from the at least one network node using secure HTTP (HTTPS);
streaming content from a network, accumulating an effective number of bits received and estimating an effective rate of each encoded representation during the streaming content; and
determining that the streaming content is being transcoded if the effective rate of each encoded representation is below a predetermined threshold as compared with the intended bandwidth attributes.

6. The method of claim 1, wherein the description file is a multimedia description file (MDP) file.

7. A method of bandwidth adaptive streaming in a wireless transmit/receive unit (WTRU) comprising:
determining at the WTRU one or more random boundaries between one or more hypertext transport protocol (HTTP) GET requests of streaming content, the one or more random boundaries producing at least one of: a reduction in an amount of transcoding, a reduction in a likelihood of transcoding, or a prevention of transcoding.

8. The method of claim 7, further comprising:
transmitting from the WTRU a first HTTP GET request for a first portion of a segment of the streaming content to a network, a first range of the first portion ending at the random boundary;
receiving the first portion of the segment of the streaming content from the network;
transmitting from the WTRU a second HTTP GET request for a second portion of the segment of the streaming content to the network; and
receiving the second portion of the segment of the streaming content from the network.

9. The method of claim 8, further comprising:
determining an access time taken to receive the first portion of the segment from the network; and
comparing the access time with an average access time of one or more previously received segments of the streaming content, the comparing providing an increase in accuracy of a bandwidth estimation.

10. The method of claim 7, further comprising:
receiving a description file from a network using secure HTTP (HTTPS);
determining if the streaming content is encrypted;
determining if one or more hash values of encoded media segments are available from the description file;
utilizing the hash values to authenticate the streaming content upon hash values being available;
utilizing the one or more HTTP GET requests for at least one segment of the streaming content upon the hash values not being available, the one or more HTTP GET requests being split requests; and
determining if one or more differences exist between the description file and one or more parameters received in the segment of the streaming content.

11. A method comprising:
receiving a Media Presentation Description (MPD) at a Dynamic Adaptive Streaming over HTTP (DASH) client device;
selecting one or more adaptation sets;
selecting one or more representations of the one or more adaptation sets;
generating a list of segments for each selected representation of the adaptation sets; and
requesting the segments based on the generated list.

12. The method of claim 11, wherein the MPD is dynamic.

13. The method of claim 11, further comprising presenting media associated with the MPD based on at least one of the one or more selected representations.

14. The method of claim 13, further comprising switching among the one or more selected representations for the presenting the media associated with the MPD.

15. The method of claim 11, further comprising accessing an HTTP server for reading one or more MPD files.

16. The method of claim 11, further comprising:
generating a data structure including one or more of a list of periods in a presentation;
generating a list of available subsets of one or more adaptation sets;
generating a list of available representations for each adaptation set;
generating a list of available sub-representations for each representation; and
determining at least one of: one or more properties of the available representations or attributes of the available representations.

17. The method of claim 11, further comprising loading one or more segment index files subsequent to a start of streaming content.

18. The method of claim 11, further comprising:
maintaining a list of one or more relevant segment indices; and
loading the one or more segments prior to accessing one or more sub-segments.

19. The method of claim 11, further comprising:
performing rate estimation based on information included in the one or more index files.

20. The method of claim 11, further comprising:
determining a buffering threshold, the buffering threshold representing a cumulative playback time;
buffering the one or more segments until the buffering threshold is reached;
identifying a stream access point (SAP) for at least one media stream associated with at least one of the one or more representations; and
rendering the SAP.
